(19) United States
(12) Patent Application Publication
(10) Pub. No.: US 2025/0056665 A1
(43) Pub. Date: Feb. 13, 2025

(54) METHOD FOR SESSION MANAGEMENT FUNCTION (SMF), AND SMF

(71) Applicant: NEC Corporation, Minato-ku, Tokyo (JP)

(72) Inventors: Iskren IANEV, Tokyo (JP); Toshiyuki Tamura, Tokyo (JP); Kundan Tiwari, Tokyo (JP)

(73) Assignee: NEC Corporation, Minato-ku, Tokyo (JP)

(21) Appl. No.: 18/718,125

(22) PCT Filed: Nov. 28, 2022
(86) PCT No.: PCT/JP2022/043677

§ 371 Date: Jun. 10, 2024

(30) Foreign Application Priority Data
Dec. 22, 2021 (IN) 202111060026

(51) Int. Cl. H04W 76/30

(52) U.S. Cl. CPC H04W 76/30

(57) ABSTRACT

A method of a communication apparatus includes sending a first message. The first message includes Single Network Slice Selection Assistance Information (S-NSSAI). The method includes receiving a second message in a case where the S-NSSAI is not used for a time period. The second message includes the S-NSSAI and a reject cause indicating that the S-NSSAI is not used for the time period. The time period is associated with the S-NSSAI. The method includes sending a third message to remove the S-NSSAI from an Allowed Network Slice Selection Assistance Information (NSSAI). The third message includes the S-NSSAI and the reject cause.

### TECHNICAL FIELD

This present disclosure relates to a method of a communication apparatus, a method of a User Equipment (UE), a communication apparatus, a UE, a method for a first core network apparatus, a method for a third core network apparatus and a method for a first network slice control function node.

### BACKGROUND ART

SA2 #148E endorsed a new Rel-18 study on network slicing (eNS_Ph3) in NPL 2. When the UE performs registration, the UE generates a Requested NSSAI based on the Configured S-NSSAI, Allowed NSSAI and also may take the URSP rules into account. The UE may register S-NSSAIs which are not going to be used (e.g. establish PDU session in the network slice by running applications) at once, and possibly not while registered in this Registration Area (RA). Similar after the applications is terminated, and the PDU session may not be used (e.g. deliver running application traffic via the PDU sessions) by any other applications in the UE. This may be perceived by operator's customers as an issue, for example when Network Slice Admission Control (NSAC) is deployed this will cause additional UE to fail to register this S-NSSAI and request S-NSSAI for PDU session. Another issue is the operator may have Service Level Agreements (SLAs) with customers related to availability of the customer's service. When the network slice is congested and other network slices can serve the SLA better the network may determine that the UE traffic flow is better served by a different network slice.

### CITATION LIST

### Non Patent Literature

[NPL 1]3GPP TR 21.905: “Vocabulary for 3GPP Specifications”. V 17.0.0 (2020 July)
[NPL 2]S2-2109356 Study on Enhancement of Network Slicing Phase 3 https://www.3gpp.org/ftp/tsg sa/WG2_Arch/TSGS2_148E_Electronic_2021-11/Doc s/S2-2109356.zip
[NPL 3]3GPP TS 23.502: “Procedures for the 5G System (5GS)”. V 17.2.0 (2021 September)

### SUMMARY OF INVENTION

### Technical Problem

One outstanding problem with the 3GPP Rel-17 agreed Network Slice Admission Control (NSACF) is whether and how to enhance the system to ensure network-controlled behavior of network slice usage including UE registration and PDU Session establishment. For example, it needs a mechanism to solve a problematic situation that the network slice cannot serve at least one of UE(s) and PDU Session(s) with actual activity when performing the NSAC. For example, it needs a mechanism to solve a problematic situation when the network slice is used by UE(s) or PDU Session (s).

### Solution to Problem

In an aspect of the present disclosure, a method of a communication apparatus includes sending a first message. The first message includes Single Network Slice Selection Assistance Information (S-NSSAI). The method includes receiving a second message in a case where the S-NSSAI is not used for a time period. The second message includes the S-NSSAI and a reject cause indicating that the S-NSSAI is not used for the time period. The time period is associated with the S-NSSAI. The method includes sending a third message to remove the S-NSSAI from an Allowed Network Slice Selection Assistance Information (NSSAI). The third message includes the S-NSSAI and the reject cause.

In an aspect of the present disclosure, a method of a communication apparatus includes receiving a first message. The first message includes Single Network Slice Selection Assistance Information (S-NSSAI). The method includes starting a timer for the S-NSSAI after receiving the first message. The timer is set to a value associated with the S-NSSAI. The method includes performing Network Slice Admission Control (NSAC) in a case where the timer expires. The method includes sending a second message after performing the NSAC. The second message includes the S-NSSAI and a reject cause indicating expiry of the timer.

In an aspect of the present disclosure, a method of a User Equipment (UE) includes performing a registration for Single Network Slice Selection Assistance Information (S-NSSAI). The method includes receiving a message. The message includes the S-NSSAI and a reject cause indicating that the S-NSSAI is not used for a time period. The time period is associated with the S-NSSAI. The method includes removing the S-NSSAI from an Allowed Network Slice Selection Assistance Information (NSSAI) after receiving the message.

In an aspect of the present disclosure, a method of a communication apparatus includes receiving a first message. The first message includes Single Network Slice Selection Assistance Information (S-NSSAI). The method includes starting a timer for the S-NSSAI after receiving the first message. The timer is set to a value associated with the S-NSSAI. The method includes sending a second message for Network Slice Admission Control (NSAC) and a third message in a case where the timer expires. The second message includes the S-NSSAI. The third message includes the S-NSSAI and a reject cause indicating expiry of the timer.

In an aspect of the present disclosure, a method of a communication apparatus includes receiving a first message. The first message includes Single Network Slice Selection Assistance Information (S-NSSAI). The method includes starting a timer for the S-NSSAI after receiving the first message. The timer is set to a value associated with the S-NSSAI. The method includes receiving a second message related to establishment of a Protocol Data Unit (PDU) session for the S-NSSAI after starting the timer. The method includes stopping the timer after receiving the second message. The method includes receiving a third message related to release of the PDU session after stopping the timer. The method includes starting the timer after receiving the third message. The method includes sending a fourth message in a case where the timer expires. The fourth message is for removing the S-NSSAI from an Allowed Network Slice Selection Assistance Information (NSSAI) or is for deregister the S-NSSAI.

In an aspect of the present disclosure, a method of a communication apparatus includes sending a first message. The first message includes Single Network Slice Selection Assistance Information (S-NSSAI). The method includes receiving a second message. The second message includes identity of a Protocol Data Unit (PDU) session. The method includes starting a timer after receiving the second message. The method includes sending a third message in a case where there is no user plane activity for the PDU session until the timer expires. The third message indicates that there is no user plane activity for the PDU session. The method includes receiving a fourth message after sending the third message. The method includes performing a procedure to release the PDU session after receiving the fourth message.

In an aspect of the present disclosure, a method of a communication apparatus includes receiving a first message. The first message includes Single Network Slice Selection Assistance Information (S-NSSAI). The method includes sending a second message. The second message includes identity of a Protocol Data Unit (PDU) session. The method includes receiving a third message after sending the second message. The third message indicates that there is no user plane activity for the PDU session. The method includes sending a fourth message after receiving the third message. The fourth message is for performing a procedure to release the PDU session.

In an aspect of the present disclosure, a communication apparatus includes means for sending a first message. The first message includes Single Network Slice Selection Assistance Information (S-NSSAI). The apparatus includes means for receiving a second message in a case where the S-NSSAI is not used for a time period. The second message includes the S-NSSAI and a reject cause indicating that the S-NSSAI is not used for the time period. The time period is associated with the S-NSSAI. The apparatus includes means for sending a third message to remove the S-NSSAI from an Allowed Network Slice Selection Assistance Information (NSSAI). The third message includes the S-NSSAI and the reject cause.

In an aspect of the present disclosure, a communication apparatus includes means for receiving a first message. The first message includes Single Network Slice Selection Assistance Information (S-NSSAI). The apparatus includes means for starting a timer for the S-NSSAI after receiving the first message. The timer is set to a value associated with the S-NSSAI. The apparatus includes means for performing Network Slice Admission Control (NSAC) in a case where the timer expires. The apparatus includes means for sending a second message after performing the NSAC. The second message includes the S-NSSAI and a reject cause indicating expiry of the timer.

In an aspect of the present disclosure, a User Equipment (UE) includes means for performing a registration for Single Network Slice Selection Assistance Information (S-NSSAI). The UE includes means for receiving a message. The message includes the S-NSSAI and a reject cause indicating that the S-NSSAI is not used for a time period. The time period is associated with the S-NSSAI. The UE includes means for removing the S-NSSAI from an Allowed Network Slice Selection Assistance Information (NSSAI) after receiving the message.

In an aspect of the present disclosure, a communication apparatus includes means for receiving a first message. The first message includes Single Network Slice Selection Assistance Information (S-NSSAI). The apparatus includes means for starting a timer for the S-NSSAI after receiving the first message. The timer is set to a value associated with the S-NSSAI. The apparatus includes means for sending a second message for Network Slice Admission Control (NSAC) and a third message in a case where the timer expires. The second message includes the S-NSSAI. The third message includes the S-NSSAI and a reject cause indicating expiry of the timer.

In an aspect of the present disclosure, a communication apparatus includes means for receiving a first message. The first message includes Single Network Slice Selection Assistance Information (S-NSSAI). The apparatus includes means for starting a timer for the S-NSSAI after receiving the first message. The timer is set to a value associated with the S-NSSAI. The apparatus includes means for receiving a second message related to establishment of a Protocol Data Unit (PDU) session for the S-NSSAI after starting the timer. The apparatus includes means for stopping the timer after receiving the second message. The apparatus includes means for receiving a third message related to release of the PDU session after stopping the timer. The apparatus includes means for starting the timer after receiving the third message. The apparatus includes means for sending a fourth message in a case where the timer expires. The fourth message is for removing the S-NSSAI from an Allowed Network Slice Selection Assistance Information (NSSAI) or is for deregister the S-NSSAI.

In an aspect of the present disclosure, a communication apparatus includes means for sending a first message. The first message includes Single Network Slice Selection Assistance Information (S-NSSAI). The apparatus includes means for receiving a second message. The second message includes identity of a Protocol Data Unit (PDU) session. The apparatus includes means for starting a timer after receiving the second message. The apparatus includes means for sending a third message in a case where there is no user plane activity for the PDU session until the timer expires. The third message indicates that there is no user plane activity for the PDU session. The apparatus includes means for receiving a fourth message after sending the third message. The apparatus includes means for performing a procedure to release the PDU session after receiving the fourth message.

In an aspect of the present disclosure, a communication apparatus includes means for receiving a first message. The first message includes Single Network Slice Selection Assistance Information (S-NSSAI). The apparatus includes means for sending a second message. The second message includes identity of a Protocol Data Unit (PDU) session. The apparatus includes means for receiving a third message after sending the second message. The third message indicates that there is no user plane activity for the PDU session. The apparatus includes means for sending a fourth message after receiving the third message. The fourth message is for performing a procedure to release the PDU session.

In an aspect of the present disclosure, a method for a first core network apparatus includes receiving, from a second core network apparatus, a fourth message related to management of a network slice. The method includes starting a timer for the network slice after receiving the fourth message. The method includes detecting the timer is expired. The method includes sending, to the second core network apparatus, a fifth message indicating at least one of the timer is expired or the network slice related to the timer is not used, after the detecting the timer is expired.

In an aspect of the present disclosure, a method for a first core network apparatus includes receiving, from a second core network apparatus, a fourth message related to management of a network slice. The method includes starting a timer for the network slice after receiving the fourth message. The method includes detecting an activity related to the network slice. The method includes stopping the timer after the detecting the activity.

In an aspect of the present disclosure, a method for a third core network apparatus includes receiving, from a first core network apparatus, a sixth message related to management of a network slice. The method includes analysing data related to the network slice based on information receive from other core network apparatus,
starting a timer for the network slice after receiving the sixth message. The method includes detecting the timer is expired. The method includes sending, to the first core network apparatus, a seventh message indicating at least one of the timer is expired or the network slice related to the timer is not used, after the detecting the timer is expired, wherein the first core network apparatus manages network slice admission control.

In an aspect of the present disclosure, a method for a third core network apparatus includes receiving, from a first core network apparatus, a sixth message related to management of a network slice. The method includes analysing data related to the network slice based on information receive from other core network apparatus. The method includes starting a timer for the network slice after the receiving the sixth message. The method includes detecting an activity related to the network slice. The method includes stopping the timer after the detecting the activity, wherein the first core network apparatus manages network slice admission control.

In an aspect of the present disclosure, a method for a first network slice control function node includes receiving, from a second core network apparatus, an eighth message related to management of a network slice. The method includes starting a timer for the network slice after receiving the eighth message. The method includes detecting the timer is expired. The method includes sending, to the second core network apparatus, a ninth message indicating at least one of the timer is expired or the network slice related to the timer is not used, after the detecting the timer is expired.

In an aspect of the present disclosure, a method for a first network slice control function node includes receiving, from a second core network apparatus, a tenth message related to management of a network slice. The method includes starting a timer for the network slice after receiving the tenth message. The method includes receiving, from a second network slice control function node, eleventh message detecting an activity related to the network slice. The method includes stopping the timer after receiving the eleventh message.

In an aspect of the present disclosure, a method for a third core network apparatus includes sending, to a first core network apparatus, first information related to management of a network slice to initiate a control of a number of session based on a timer. The method includes receiving, from the first core network apparatus, second information indicating the control is initiated. The method includes monitoring user plane activity related to the session after receiving the second information. The method includes sending, to the first core network apparatus, third information indicating the user plane activity is not detected based on the monitoring. The method includes receiving, from the first core network apparatus, fourth information indicating at least one of the timer is expired or the session is not active within a period specified by the timer.

In an aspect of the present disclosure, a method for a first core network apparatus includes receiving, from a third core network apparatus, fifth information related to management of a network slice. The method includes starting a timer for the network slice after receiving the fifth information. The method includes sending, to the third core network apparatus, sixth information indicating the management is initiated to start monitoring user plane activity related to a session. The method includes receiving, from the third core network apparatus, seventh information indicating the user plane activity is not detected based on the monitoring. The method includes sending, to the third core network apparatus, eighth information indicating at least one of the timer is expired or the session is not active within a period specified by the timer.

### BRIEF DESCRIPTION OF DRAWINGS

FIG. 1 is a signaling diagram of a First Example of the First Aspect (Network slice usage control for UE registrations by NSACF).

FIG. 2 is a signaling diagram of a Second Example of the First Aspect (Network slice usage control for UE registrations by NWDAF).

FIG. 3 is a signaling diagram of a Third Example of the First Aspect (Network slice usage control for UE registrations by two NSACFs).

FIG. 4 is a signaling diagram of a Fourth Example of the First Aspect (Network slice usage control for PDU sessions by NSACF).

FIG. 5 is a diagram illustrating a system overview.

FIG. 6 is a block diagram illustrating a User equipment (UE).

FIG. 7 is a block diagram illustrating a (R)AN node.

FIG. 8 is a diagram illustrating System overview of (R)AN node based on O-RAN architecture.

FIG. 9 is a block diagram illustrating a Radio Unit (RU).

FIG. 10 is a block diagram illustrating a Distributed Unit (DU).

FIG. 11 is a block diagram illustrating a Centralized Unit (CU).

FIG. 12 is a block diagram illustrating an Access and Mobility Management Function (AMF).

FIG. 13 is a block diagram illustrating a User Plane Function (UPF).

FIG. 14 is a block diagram illustrating a Policy Control Function (PCF).

FIG. 15 is a block diagram illustrating an Authentication Server Function (AUSF).

FIG. 16 is a block diagram illustrating a Unified Data Management (UDM).

FIG. 17 is a block diagram illustrating a Network Data Analytics Function (NWDAF).

FIG. 18 is a block diagram illustrating a Network Slice Admission Control Function (NSACF).

FIG. 19 illustrates a Number of UEs per network slice availability check and update procedure.

FIG. 20 illustrates a Number of PDU Sessions per network slice availability check and update procedure.

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QoS Identifier
AF Application Function
AMF Access and Mobility Management Function
AMF-G Geographically selected Access and Mobility Management Function
AMF-NG Non-Geographically selected Access and Mobility Management Function
AS Access Stratum
ATSSS Access Traffic Steering, Switching, Splitting
ATSSS-LL ATSSS Low-Layer
AUSF Authentication Server Function
AUTN Authentication token
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MNC Mobile Network Code
MPS Multimedia Priority Service
MPTCP Multi-Path TCP Protocol
N3IWF Non-3GPP InterWorking Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSAC Network Slice Admission Control
NSACF Network Slice Admission Control Function
NSI ID Network Slice Instance Identifier
NSSAA Network Slice-Specific Authentication and Authorization
NSSAAF Network Slice-Specific Authentication and Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDR Packet Detection Rule
PDU Protocol Data Unit
PEI Permanent Equipment Identifier
PER Packet Error Rate
PFD Packet Flow Description
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited PLMN
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### <General>

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

A method of a communication apparatus according to example aspect of this disclosure includes sending a first message. The first message includes Single Network Slice Selection Assistance Information (S-NSSAI). The method includes receiving a second message in a case where the S-NSSAI is not used for a time period. The second message includes the S-NSSAI and a reject cause indicating that the S-NSSAI is not used for the time period. The time period is associated with the S-NSSAI. The method includes sending a third message to remove the S-NSSAI from an Allowed Network Slice Selection Assistance Information (NSSAI). The third message includes the S-NSSAI and the reject cause.

A method of a communication apparatus according to example aspect of this disclosure includes receiving a first message. The first message includes Single Network Slice Selection Assistance Information (S-NSSAI). The method includes starting a timer for the S-NSSAI after receiving the first message. The timer is set to a value associated with the S-NSSAI. The method includes performing Network Slice Admission Control (NSAC) in a case where the timer expires. The method includes sending a second message after performing the NSAC. The second message includes the S-NSSAI and a reject cause indicating expiry of the timer.

A method of a User Equipment (UE) according to example aspect of this disclosure includes performing a registration for Single Network Slice Selection Assistance Information (S-NSSAI). The method includes receiving a message. The message includes the S-NSSAI and a reject cause indicating that the S-NSSAI is not used for a time period. The time period is associated with the S-NSSAI. The method includes removing the S-NSSAI from an Allowed Network Slice Selection Assistance Information (NSSAI) after receiving the message.

A method of a communication apparatus according to example aspect of this disclosure includes receiving a first message. The first message includes Single Network Slice Selection Assistance Information (S-NSSAI). The method includes starting a timer for the S-NSSAI after receiving the first message. The timer is set to a value associated with the S-NSSAI. The method includes sending a second message for Network Slice Admission Control (NSAC) and a third message in a case where the timer expires. The second message includes the S-NSSAI. The third message includes the S-NSSAI and a reject cause indicating expiry of the timer.

A method of a communication apparatus according to example aspect of this disclosure includes receiving a first message. The first message includes Single Network Slice Selection Assistance Information (S-NSSAI). The method includes starting a timer for the S-NSSAI after receiving the first message. The timer is set to a value associated with the S-NSSAI. The method includes receiving a second message related to establishment of a Protocol Data Unit (PDU) session for the S-NSSAI after starting the timer. The method includes stopping the timer after receiving the second message. The method includes receiving a third message related to release of the PDU session after stopping the timer. The method includes starting the timer after receiving the third message. The method includes sending a fourth message in a case where the timer expires. The fourth message is for removing the S-NSSAI from an Allowed Network Slice Selection Assistance Information (NSSAI) or is for deregister the S-NSSAI.

A method of a communication apparatus according to example aspect of this disclosure includes sending a first message. The first message includes Single Network Slice Selection Assistance Information (S-NSSAI). The method includes receiving a second message. The second message includes identity of a Protocol Data Unit (PDU) session. The method includes starting a timer after receiving the second message. The method includes sending a third message in a case where there is no user plane activity for the PDU session until the timer expires. The third message indicates that there is no user plane activity for the PDU session. The method includes receiving a fourth message after sending the third message. The method includes performing a procedure to release the PDU session after receiving the fourth message.

A method of a communication apparatus according to example aspect of this disclosure includes receiving a first message. The first message includes Single Network Slice Selection Assistance Information (S-NSSAI). The method includes sending a second message. The second message includes identity of a Protocol Data Unit (PDU) session. The method includes receiving a third message after sending the second message. The third message indicates that there is no user plane activity for the PDU session. The method includes sending a fourth message after receiving the third message. The fourth message is for performing a procedure to release the PDU session.

A communication apparatus according to example aspect of this disclosure includes a memory, and at least one hardware processor coupled to the memory. The at least one hardware processor is configured to send a first message. The first message includes Single Network Slice Selection Assistance Information (S-NSSAI). The at least one hardware processor is configured to receive a second message in a case where the S-NSSAI is not used for a time period. The second message includes the S-NSSAI and a reject cause indicating that the S-NSSAI is not used for the time period. The time period is associated with the S-NSSAI. The at least one hardware processor is configured to send a third message to remove the S-NSSAI from an Allowed Network Slice Selection Assistance Information (NSSAI). The third message includes the S-NSSAI and the reject cause.

A communication apparatus according to example aspect of this disclosure includes a memory, and at least one hardware processor coupled to the memory. The at least one hardware processor is configured to receive a first message. The first message includes Single Network Slice Selection Assistance Information (S-NSSAI). The at least one hardware processor is configured to start a timer for the S-NSSAI after receiving the first message. The timer is set to a value associated with the S-NSSAI. The at least one hardware processor is configured to perform Network Slice Admission Control (NSAC) in a case where the timer expires. The at least one hardware processor is configured to send a second message after performing the NSAC. The second message includes the S-NSSAI and a reject cause indicating expiry of the timer.

A User Equipment (UE) according to example aspect of this disclosure includes a memory, and at least one hardware processor coupled to the memory. The at least one hardware processor is configured to perform a registration for Single Network Slice Selection Assistance Information (S-NSSAI). The at least one hardware processor is configured to receive a message. The message includes the S-NSSAI and a reject cause indicating that the S-NSSAI is not used for a time period. The time period is associated with the S-NSSAI. The at least one hardware processor is configured to remove the S-NSSAI from an Allowed Network Slice Selection Assistance Information (NSSAI) after receiving the message.

A communication apparatus according to example aspect of this disclosure includes a memory, and at least one hardware processor coupled to the memory. The at least one hardware processor is configured to receive a first message. The first message includes Single Network Slice Selection Assistance Information (S-NSSAI). The at least one hardware processor is configured to start a timer for the S-NSSAI after receiving the first message. The timer is set to a value associated with the S-NSSAI. The at least one hardware processor is configured to send a second message for Network Slice Admission Control (NSAC) and a third message in a case where the timer expires. The second message includes the S-NSSAI. The third message includes the S-NSSAI and a reject cause indicating expiry of the timer.

A communication apparatus according to example aspect of this disclosure includes a memory, and at least one hardware processor coupled to the memory. The at least one hardware processor is configured to receive a first message. The first message includes Single Network Slice Selection Assistance Information (S-NSSAI). The at least one hardware processor is configured to start a timer for the S-NSSAI after receiving the first message. The timer is set to a value associated with the S-NSSAI. The at least one hardware processor is configured to receive a second message related to establishment of a Protocol Data Unit (PDU) session for the S-NSSAI after starting the timer. The at least one hardware processor is configured to stop the timer after receiving the second message. The at least one hardware processor is configured to receive a third message related to release of the PDU session after stopping the timer. The at least one hardware processor is configured to start the timer after receiving the third message. The at least one hardware processor is configured to send a fourth message in a case where the timer expires. The fourth message is for removing the S-NSSAI from an Allowed Network Slice Selection Assistance Information (NSSAI) or is for deregister the S-NSSAI.

A communication apparatus according to example aspect of this disclosure includes a memory, and at least one hardware processor coupled to the memory. The at least one hardware processor is configured to send a first message. The first message includes Single Network Slice Selection Assistance Information (S-NSSAI). The at least one hardware processor is configured to receive a second message. The second message includes identity of a Protocol Data Unit (PDU) session. The at least one hardware processor is configured to start a timer after receiving the second message. The at least one hardware processor is configured to send a third message in a case where there is no user plane activity for the PDU session until the timer expires. The third message indicates that there is no user plane activity for the PDU session. The at least one hardware processor is configured to receive a fourth message after sending the third message. The at least one hardware processor is configured to perform a procedure to release the PDU session after receiving the fourth message.

A communication apparatus according to example aspect of this disclosure includes a memory, and at least one hardware processor coupled to the memory. The at least one hardware processor is configured to receive a first message. The first message includes Single Network Slice Selection Assistance Information (S-NSSAI). The at least one hardware processor is configured to send a second message. The second message includes identity of a Protocol Data Unit (PDU) session. The at least one hardware processor is configured to receive a third message after sending the second message. The third message indicates that there is no user plane activity for the PDU session. The at least one hardware processor is configured to send a fourth message after receiving the third message. The fourth message is for performing a procedure to release the PDU session.

A method of a first core network apparatus according to example aspect of this disclosure includes receiving, from a second core network apparatus, a fourth message related to management of a network slice. The method includes starting a timer for the network slice after receiving the fourth message. The method includes detecting the timer is expired. The method includes sending, to the second core network apparatus, a fifth message indicating at least one of the timers is expired or the network slice related to the timer is not used, after the detecting the timer is expired.

A method of a first core network apparatus according to example aspect of this disclosure includes receiving, from a second core network apparatus, a fourth message related to management of a network slice. The method includes starting a timer for the network slice after receiving the fourth message. The method includes detecting an activity related to the network slice. The method includes stopping the timer after the detecting the activity.

A method of a third core network apparatus according to example aspect of this disclosure includes receiving, from a first core network apparatus, a sixth message related to management of a network. The method includes analysing data related to the network slice based on information receive from other core network apparatus. The method includes starting a timer for the network slice after receiving the sixth message. The method includes detecting the timer is expired. The method includes sending, to the first core network apparatus, a seventh message indicating at least one of the timers is expired or the network slice related to the timer is not used, after the detecting the timer is expired. The first core network apparatus manages network slice admission control.

A method of a third core network apparatus according to example aspect of this disclosure includes receiving, from a first core network apparatus, a sixth message related to management of a network slice. The method includes analysing data related to the network slice based on information receive from other core network apparatus. The method includes starting a timer for the network slice after the receiving the sixth message. The method includes detecting an activity related to the network slice. The method includes stopping the timer after the detecting the activity. The first core network apparatus manages network slice admission control.

A method of a first network slice control function node according to example aspect of this disclosure includes receiving, from a second core network apparatus, an eighth message related to management of a network slice. The method includes starting a timer for the network slice after receiving the eighth message. The method includes detecting the timer is expired. The method includes sending, to the second core network apparatus, a ninth message indicating at least one of the timer is expired or the network slice related to the timer is not used, after the detecting the timer is expired.

A method of a first network slice control function node according to example aspect of this disclosure includes receiving, from a second core network apparatus, a tenth message related to management of a network slice. The method includes starting a timer for the network slice after receiving the tenth message. The method includes receiving, from a second network slice control function node, eleventh message detecting an activity related to the network slice. The method includes stopping the timer after receiving the eleventh message.

A method of a third core network apparatus node according to example aspect of this disclosure includes sending, to a first core network apparatus, first information related to management of a network slice to initiate a control of a number of sessions based on a timer. The method includes receiving, from the first core network apparatus, second information indicating the control is initiated. The method includes monitoring user plane activity related to the sessions after receiving the second information. The method includes sending, to the first core network apparatus, third information indicating the user plane activity is not detected based on the monitoring. The method includes receiving, from the first core network apparatus, fourth information indicating at least one of the timer is expired or the session is not active within a period specified by the timer.

A method of a third first core network apparatus node according to example aspect of this disclosure includes receiving, from a third core network apparatus, fifth information related to management of a network slice. The method includes starting a timer for the network slice after receiving the fifth information. The method includes sending, to the third core network apparatus, sixth information indicating the management is initiated to start monitoring user plane activity related to a session. The method includes receiving, from the third core network apparatus, seventh information indicating the user plane activity is not detected based on the monitoring. The method includes sending, to the third core network apparatus, eighth information indicating at least one of the timer is expired or the session is not active within a period specified by the timer.

### <First Aspect>

The First Aspect discloses a mechanism which enables the network to deregister the UE from a network slice if the network slice is not used for a long time. For example, the First Aspect discloses a mechanism which enables the network to deregister the UE from a network slice if there is no PDU sessions established by the UE on the network slice for a duration of time defined by the network operator. For example, the First Aspect discloses a mechanism which enables the network to deregister the UE from a network slice if the number of UE registrations with the network slice has reached a certain threshold, e.g. the maximum number of UEs registered with the network slice. For example, the First Aspect discloses a mechanism which enables the network to deregister the UE from a network slice if the network slice is overloaded.

For example, the First Aspect can solve the problem whether and how to enhance the system to ensure network-controlled behavior of network slice usage including UE registration and PDU Session establishment.

For example, the First Aspect can solve the problematic situation that the network slice cannot serve at least one of UE(s) and PDU Session(s) with actual activity when performing the NSAC.

For example, the First Aspect can solve the problematic situation when the network slice is used by UE(s) or PDU Session (s).

### First Example of the First Aspect

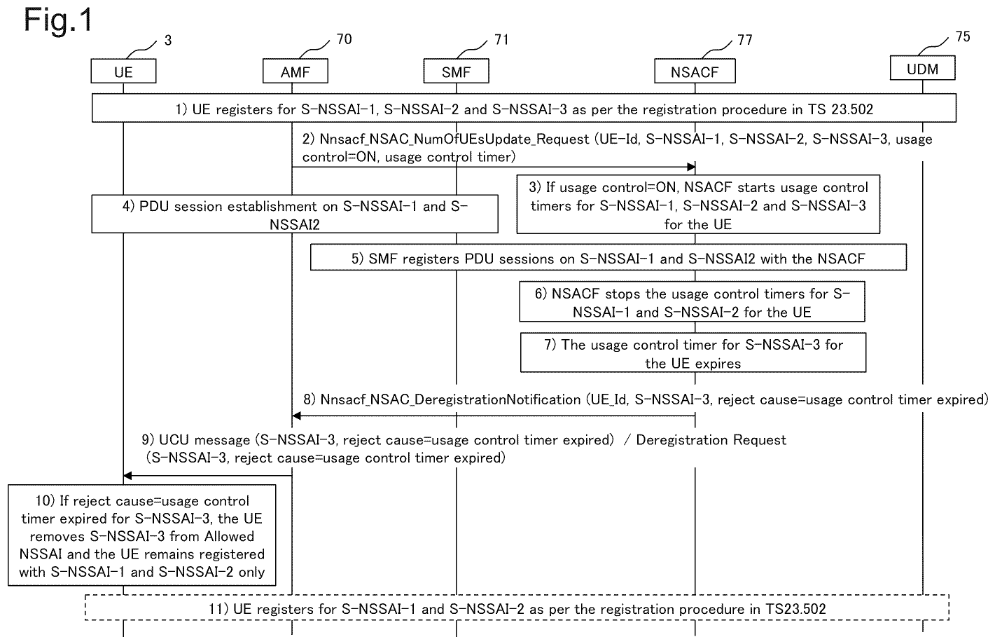

The First Example of the First Aspect in FIG. 1 discloses a mechanism which enables a network to deregister a UE 3 from a network slice via the NSACF 77 if the network slice is not used for a long time. For example, the First Example of the First Aspect in FIG. 1 discloses a mechanism which enables the network to deregister the UE 3 from a network slice via the NSACF 77 if there is no PDU sessions established by the UE 3 on the network slice for a duration of a time defined by the network operator, for example. For example, the First Example of the First Aspect in FIG. 1 discloses a mechanism which enables the network to deregister the UE 3 from a network slice via the NSACF 77 if the number of UE registrations with the network slice has reached a certain threshold, e.g. the maximum number of UEs registered with the network slice or a threshold defined by the operator. For example, the First Example of the First Aspect in FIG. 1 discloses a mechanism which enables the network to deregister the UE 3 from a network slice via the NSACF 77 if the network slice is overloaded.
1. A UE 3 registers with an AMF 70 for network slice(s), e.g. network slices which are identified by S-NSSAI-1, S-NSSAI-2 and S-NSSAI-3 and which are supported by a network and by the AMF 70 in the UE 3's location. For example, the UE 3 may perform a registration procedure for S-NSSAI-1, S-NSSAI-2 and S-NSSAI-3 as per NPL 3. “network slice(s) identified by S-NSSAI(s)” may be expressed as “network slice(s)” or “S-NSSAI(s)” in this disclosure.
2. If the network slices identified by S-NSSAI-1, S-NSSAI-2 and S-NSSAI-3 are subject to Network Slice Admission Control (NSAC), the AMF 70 registers the UE 3 for each one of these network slices with an NSACF 77 for the purpose of the quota control, i.e. control of the number of the UEs registered with a network slice not to exceed the maximum number of the UEs allowed to register with that network slice or a threshold number defined by the operator. The AMF 70 may find out whether a network slice is subject to NSAC via interacting with a UDM 75 and retrieving UE 3's subscription information along with information whether the network slice is subject to NSAC. For example, the AMF 70 may already have the subscription information for the UE 3 in a UE 3's context within the AMF 70. For example, the AMF 70 may be configured with information about whether a network slice is subject to NSAC or not.

If the requested network slices which are identified by S-NSSAI-1, S-NSSAI-2 and S-NSSAI-3 and which are requested by the UE 3 are subject to NSAC, the AMF 70 registers the UE 3 for these network slices by sending an Nnsacf_NSAC_NumOfUEsUpdate_Request message to the NSACF 77. The AMF 70 includes in the message the UE 3's identity (e.g. UE-Id), S-NSSAI-1, S-NSSAI-2, S-NSSAI-3 which identify the requested network slices and a parameter called ‘usage control’ set to ON or ‘inactivity control’ set to ON or any other notation for a parameter in order to indicate to the NSACF 77 that the network slice(s) is subject to usage control or subject to inactivity control. The ‘usage control’ set to ON or the ‘inactivity control’ set to ON may indicate that the UE 3 is to be deregistered from the network slice if the network slice is not used by the UE 3 for certain time. “identity” may be expressed as “identifier” in this disclosure.

The ‘usage control’ or the ‘inactivity control’ or any other notation for a parameter in order to indicate to the NSACF 77 that the network slice(s) is subject to usage control or subject to inactivity control may be collectively expressed as ‘usage control’ or ‘usage control’ parameter.

For example, the ‘usage control’ may be related to S-NSSAI(s) that the UE 3 registers. For example, the ‘usage control’ set to ON may be related to S-NSSAI-1, S-NSSAI-2 and S-NSSAI-3.

The AMF 70 may also include, in the Nnsacf_NSAC_NumOfUEsUpdate_Request message, ‘usage control timer’ parameter or ‘inactivity control timer’ parameter or any other notation for a parameter in order to define a time or time period for which if the network slice(s) is not used by the UE 3, e.g. if no service request or no PDU session is established by the UE 3 on the network slice(s), the UE 3 is to be deregistered from the network slice(s).

The ‘usage control timer’ parameter or the ‘inactivity control timer’ parameter or any other notation for a parameter in order to define a time or time period for which if the network slice(s) is not used by the UE 3, the UE 3 is to be deregistered from the network slice(s) may be collectively expressed as ‘usage control timer’ or ‘usage control timer’ parameter.

For example, the AMF 70 may configure the ‘usage control timer’ parameter based on a local configuration in the AMF 70 or network operator policy within the AMF 70. Alternatively, the ‘usage control timer’ parameter could be configured in the NSACF 77 or the ‘usage control timer’ parameter is based on network operator policy within the NSACF 77. For example, the AMF 70 or the NSACF 77 may determine value of the ‘usage control timer’ parameter.

For example, the ‘usage control timer’ parameter may be related to S-NSSAI(s) that the UE 3 registers. For example, the ‘usage control timer’ may be related to S-NSSAI-1, S-NSSAI-2 and S-NSSAI-3. Value of the ‘usage control timer’ parameter may be same to S-NSSAI-1, S-NSSAI-2 and S-NSSAI-3 or be different for S-NSSAI-1, S-NSSAI-2 and S-NSSAI-3. Value of the ‘usage control timer’ parameter may be expressed as a value associated with S-NSSAI-1, S-NSSAI-2 and S-NSSAI-3.

For example, the AMF 70 may send the Nnsacf_NSAC_NumOfUEsUpdate_Request message during a registration procedure for S-NSSAI-1, S-NSSAI-2 and S-NSSAI-3. For example, the AMF 70 may send, to the NSACF 77, a message related to a network slice. For example, the AMF 70 may send, to the NSACF 77, a message related to management of a network slice. For example, the AMF 70 may send, to the NSACF 77, a message related to management of a number of UE(s) registered with a network slice.

The Nnsacf_NSAC_NumOfUEsUpdate_Request message may be sent for the NSAC.

For example, the NSACF 77 may not start the usage control timer for network slice(s) (e.g. S-NSSAI-1, S-NSSAI-2, and S-NSSAI-3) in a case where the number of registered UEs on the network slice(s) exceeds the maximum number of the UEs allowed to register with that network slice(s) or a threshold number defined by the operator. In this case, the NSACF 77 may send, to the AMF 70, information indicating that the UE identified by the UE-Id cannot be registered to the network slice(s).
3. The NSACF 77 receives the Nnsacf_NSAC_NumOfUEsUpdate_Request message from the AMF 70.

If the network slice for which the UE 3 registers for is subject to usage or inactivity control, e.g. the ‘usage control’ parameter from the AMF 70 is set ON, the NSACF 77 starts a timer which measures the time for which a network slice has not been used by the UE 3, e.g. for which no service is requested or no PDU session is established by the UE 3 on that network slice or no data was exchanged on an established PDU session. The timer may be called as, for example, ‘usage control timer’ or ‘inactivity control timer’ or any other notation for a timer. The ‘usage control timer’ or the ‘inactivity control timer’ or any other notation for a timer may be collectively expressed as ‘usage control timer’.

The ‘usage control timer’ or the ‘inactivity control timer’ may be set to a value configured in the NSACF 77 by the operator. The ‘usage control timer’ or ‘the ‘inactivity control timer’ may be set to a value indicated by the AMF 70 in the ‘usage control timer’ parameter or the ‘inactivity control timer’ parameter.

The NSACF 77 runs the ‘usage control timer’ for each network slice which is subject to usage control, e.g. a network slice for which the ‘usage control’ parameter is set to ON. For example, the NSACF 77 runs the ‘usage control timers’ for at least one of S-NSSAI-1, S-NSSAI-2 and S-NSSAI-3. The ‘usage control timer’ may be controlled per UE in this disclosure. For example, the NSACF 77 may control the ‘usage control timer’ per UE identified by the UE-Id. For example, the NSACF 77 may run the ‘usage control timers’ regarding at least one of S-NSSAI-1, S-NSSAI-2 and S-NSSAI-3 for the UE 3.
4. At some stage of the UE 3 that has an Allowed NSSAI including S-NSSAI-1, S-NSSAI-2 and S-NSSAI-3, the UE 3 requests a service or PDU session establishment on S-NSSAI-1 and S-NSSAI-2, for example.
5. An SMF 71 registers PDU session(s) established on S-NSSAI-1 and S-NSSAI-2 with the NSACF 77 for the maximum number of PDU sessions quota control. For example, the NSACF 77 detects an activity related to a network slice (e.g. a network slice identified by S-NSSAI-1 or S-NSSAI-2). For example, the SMF 71 may send, to the NSACF 77, a message to register the PDU session(s) established on S-NSSAI-1 and S-NSSAI-2. The message may be expressed as registration notification.
6. If network slices identified by S-NSSAI-1 and S-NSSAI-2 are subject to usage control, i.e. if the NSACF 77 has active usage control timers running for the UE 3 for S-NSSAI-1 and S-NSSAI-2, the NSACF 77 stop the ‘usage control timer’ for S-NSSAI-1 and the ‘usage control timer’ for S-NSSAI-2 as these two network slices have been used i.e. the PDU session(s) is established, by the UE 3, on network slices identified by S-NSSAI-1 and S-NSSAI-2 before their usage control timers expired. For example, in a case where the NSACF 77 receives the registration notification from the SMF 71 in step 5, the NSACF 77 may stop the usage control timers for S-NSSAI-1 and S-NSSAI-2 which start in step 3. For example, in a case where the NSACF 77 receives the registration notification from the SMF 71 in step 5, the NSACF 77 may recognize that the network slices identified by S-NSSAI-1 and S-NSSAI-2 have been used i.e. the PDU session(s) is established, by the UE 3, on network slices identified by S-NSSAI-1 and S-NSSAI-2, and the NSACF 77 may stop the usage control timers for S-NSSAI-1 and S-NSSAI-2 which start in step 3. For example, in a case where the NSACF 77 receives a message indicating an activity related to the network slice identified by S-NSSAI-1 or S-NSSAI-2, the NSACF 77 may stop the usage control timers for S-NSSAI-1 and S-NSSAI-2 which start in step 3. The registration notification may be expressed as a message related to PDU session(s) for S-NSSAI-1 and S-NSSAI-2.

When the UE 3 stops using network slices identified by S-NSSAI-1 and S-NSSAI-2, i.e. the UE 3 releases the PDU session(s) on S-NSSAI-1 and S-NSSAI-2, the NSACF 77 re-starts the usage control timers for S-NSSAI-1 and S-NSSAI-2. For example, in a case where the NSACF 77 receives release notification for the PDU session(s) on S-NSSAI-1 and S-NSSAI-2 from the SMF 71, the NSACF 77 may re-start the usage control timers for S-NSSAI-1 and S-NSSAI-2.
7. The ‘usage control timer’ for S-NSSAI-3 for the UE 3 expires. As the UE 3 has not used S-NSSAI-3, i.e. the UE 3 has not requested service or has not established a PDU session on S-NSSAI-3 for some time, the ‘usage control timer’ for the UE 3 for S-NSSAI-3 expires.
8. The NSACF 77 sends an Nnsacf_NSAC_DeregistrationNotification message including UE_Id, S-NSSAI-3, reject cause which is set to ‘usage control timer expired’ to the AMF 70 to indicate that the NSACF 77 wants to deregister the UE 3 for S-NSSAI-3 as the UE 3 has not used S-NSSAI-3 until the expiry of the ‘usage control timer’ for S-NSSAI-3 for UE 3. For example, after the step 7, the NSACF 77 may send, to the AMF 70, a message indicating a network slice (e.g. a network slice identified by S-NSSAI-3) is not used. For example, the NSACF 77 may send, to the AMF 70, the Nnsacf_NSAC_DeregistrationNotification message in a case where the S-NSSAI-3 is not used for a time period. The NSACF 77 may include in the Nnsacf_NSAC_DeregistrationNotification message to the AMF 70 parameters mentioned below:
   UE-Id—identity of the UE 3 which is to be deregistered.
   S-NSSAI-3—network slice identity for which the UE 3 is to be deregistered by the NSACF 77 or network slice identity that the UE 3 has not used, or network slice identity for which the ‘usage control timer’ expires.
   Reject cause which is set to ‘usage control timer expired’—This reject cause indicates reason for the UE 3 deregistration from S-NSSAI-3. For example, the reject cause may indicate that the UE 3 has not requested service or has not established a PDU session on a network slice which is identified by S-NSSAI-3 until the expiry of the ‘usage control timer’ for UE 3. The reject cause may be associated with S-NSSAI-3. The reject cause which is set to ‘usage control timer expired’” may be expressed as Reject cause=‘usage control timer expired’. The reject cause may indicate that the UE 3 does not use a network slice which is identified with S-NSSAI-3 until the expiry of the ‘usage control timer’ for UE 3. The reject cause may indicate that S-NSSAI-3 is not used for a time period. The reject cause may indicate that S-NSSAI-3 is not used for a time period identified by the ‘usage control timer’ parameter. The reject cause may indicate expiry of the ‘usage control timer’.

The NSACF 77 also updates the number of the UEs registered with S-NSSAI-3 by decreasing the number of the registered UEs with S-NSSAI-3 by 1 and also the NSACF 77 removes the UE 3's identity, e.g. the UE-Id from a list of the UEs registered with S-NSSAI-3.

For example, in a case where the NSACF 77 updates the number of the UEs registered with S-NSSAI-3, the NSACF 77 may perform quota control (e.g. NSAC) for the registered UEs as per clause 4.2.11 of NPL 3.

For example, the NSACF 77 may send the Nnsacf_NSAC_DeregistrationNotification message in a case where the ‘usage control timer’ for S-NSSAI-3 for the UE 3 expires.

For example, the NSAC (e.g. decrement or decreasing the number of the registered UEs with S-NSSAI-3 by 1) by the NSACF 77 may be performed in a case where the ‘usage control timer’ for S-NSSAI-3 for the UE 3 expires.

For example, the NSAC (e.g. decrement or decreasing the number of the registered UEs with S-NSSAI-3 by 1) by the NSACF 77 may be performed in a case where time period indicated by the ‘usage control timer’ parameter lapses.
9. The AMF 70 receives the Nnsacf_NSAC_DeregistrationNotification message from the NSACF 77. Upon receiving the Nnsacf_NSAC_DeregistrationNotification message, if the UE 3 is in connected mode, the AMF 70 may deregister the UE 3 for S-NSSAI-3 via a UE Configuration Update message in which the AMF 70 removes S-NSSAI-3 from the Allowed NSSAI and adds S-NSSAI-3 to the Rejected NSSAI. The AMF 70 may send the UE Configuration Update message to UE (e.g. UE 3) identified by the UE-Id. For example, the UE Configuration Update message may be expressed as UCU message. For example, the AMF 70 may include, in the UCU message, information to instruct the UE 3 to remove S-NSSAI-3 from the Allowed NSSAI and add S-NSSAI 3 to the Rejected NSSAI. For example, in a case where the AMF 70 send the UCU message, the AMF 70 removes S-NSSAI-3 from the Allowed NSSAI for the UE 3 stored in the AMF 70 and adds S-NSSAI-3 to the Rejected NSSAI for the UE 3 stored in the AMF 70.

The AMF 70 also includes, in the UCU message, a reject cause for S-NSSAI-3, e.g. reject cause which is set to ‘usage control timer expired’ or ‘inactivity control timer expired’ or any other notation for a reject cause in order to indicate that the rejection is due to a network slice not being used by the UE 3 until the expiry of the usage control timer for the UE 3 for that network slice. The reject cause may be same to one in the Nnsacf_NSAC_DeregistrationNotification message. The reject cause may indicate same one in the Nnsacf_NSAC_DeregistrationNotification message.

Alternatively, the AMF 70 may use existing UE deregistration procedure by sending Deregistration Request message to the UE 3 in which the AMF 70 includes the network slice, e.g. S-NSSAI-3 for which the UE 3 is rejected from registration and a reject cause which is set to ‘usage control timer expired’.

Upon receiving the Nnsacf_NSAC_DeregistrationNotification message, if the UE 3 is in idle mode, the AMF 70 either:
Pages the UE 3 and after connecting with the UE 3 the AMF 70 sends the UE Configuration Update message to the UE 3 with the rejected S-NSSAI-3 and the reject cause which is set to ‘usage control timer expired’; or
Stores the information from the Nnsacf_NSAC_DeregistrationNotification message from the NSACF 77 until when the UE 3 connects back to the network, e.g. for service or PDU session establishment. In a case where the UE 3 connects back to the network, the AMF 70 provides the rejected S-NSSAI-3 and the reject cause which is set to ‘usage control timer expired’ to the UE 3 via the UE Configuration Update message.

The AMF 70 may store information indicating whether the UE 3 is in connected mode or is in idle mode. The AMF 70 may receive information indicating whether the UE 3 is in connected mode or is in idle mode from other network node. The AMF 70 may determine whether the UE 3 is in connected mode or is in idle mode based on the information indicating whether the UE 3 is in connected mode or is in idle mode. The UCU message or the Deregistration Request message may be sent for at least one of removing S-NSSAI-3 from the Allowed NSSAI and adding S-NSSAI-3 to the Rejected NSSAI.
10. If the UE 3 receives a registration rejection for a network slice, e.g. S-NSSAI-3 via the UE Configuration Update message or via the UE Deregistration message with a reject cause which is set to ‘usage control timer expired’, the UE 3 removes the rejected S-NSSAI-3 from the Allowed NSSAI and the UE 3 continues to be registered for S-NSSAI-1 and S-NSSAI-2. The UE 3 may add the rejected S-NSSAI-3 to the Rejected NSSAI.
11. Optionally, the UE 3 may refresh its registration by triggering a new registration procedure for S-NSSAI-1 and S-NSSAI-2 as per a registration procedure in NPL 3.

For example, a communication apparatus corresponding to the AMF 70 may send a first message. The first message may include Single Network Slice Selection Assistance Information (S-NSSAI). The communication apparatus may receive a second message in a case where the S-NSSAI is not used for a time period. The second message may include the S-NSSAI and a reject cause indicating that the S-NSSAI is not used for the time period. The time period may be associated with the S-NSSAI. The communication apparatus may send a third message to remove the S-NSSAI from an Allowed Network Slice Selection Assistance Information (NSSAI). The third message may include the S-NSSAI and the reject cause.

For example, a communication apparatus corresponding to the NSACF 77 may receive a first message. The first message may include Single Network Slice Selection Assistance Information (S-NSSAI). The communication apparatus may start a timer for the S-NSSAI after receiving the first message. The timer may be set to a value associated with the S-NSSAI. The communication apparatus may perform Network Slice Admission Control (NSAC) in a case where the timer expires. The communication apparatus may send a second message after performing the NSAC. The second message may include the S-NSSAI and a reject cause indicating expiry of the timer.

For example, a User Equipment (UE) corresponding to the UE 3 may perform a registration for Single Network Slice Selection Assistance Information (S-NSSAI). The UE may receive a message. The message may include the S-NSSAI and a reject cause indicating that the S-NSSAI is not used for a time period. The time period may be associated with the S-NSSAI. The UE may remove the S-NSSAI from an Allowed Network Slice Selection Assistance Information (NSSAI) after receiving the message.

For example, a first core network apparatus corresponding to the NSACF 77 may receive, from a second core network apparatus corresponding to the AMF 70, a message related to management of a network slice. The first core network apparatus may start a timer for the network slice after receiving the message. The first core network apparatus may detect the timer is expired. The first core network apparatus may send, to the second core network apparatus, a message indicating at least one of the timer is expired or the network slice related to the timer is not used, after detecting the timer is expired.

For example, a first core network apparatus corresponding to the NSACF 77 may receive, from a second core network apparatus corresponding to the AMF 70, a message related to management of a network slice. The first core network apparatus may start a timer for the network slice after receiving the message. The first core network apparatus may detect an activity related to the network slice. The first core network apparatus may stop the timer after detecting the activity

According to the above, the above problem such as whether and how to enhance the system to ensure network-controlled behavior of network slice usage including UE registration and PDU Session establishment can be solved.

### Variant 1 of the First Example of the First Aspect

In step 8 of FIG. 1, the NSACF 77 may include a network slice usage back-off timer in the Nnsacf_NSAC_DeregistrationNotification message to the AMF 70. If the network slice usage back-off timer is included by the NSACF 77, the AMF 70 relays the network slice usage back-off timer to the UE 3 in step 9. If the UE 3 receives rejection for a network slice (e.g. S-NSSAI-3) with reject cause which is set to ‘usage control timer expired’ and the network slice usage back-off timer, the UE 3 starts the network slice usage back-off timer and the UE 3 does not request registration for the rejected network slice, e.g. S-NSSAI-3, while the network slice usage back-off timer for S-NSSAI-3 is running. The UE 3 may request registration for the rejected network slice, e.g. S-NSSAI-3 in a case where the network slice usage back-off timer for S-NSSAI-3 expires. Cell reselection and registration area updates by the UE 3 do not reset the network slice usage back-off timer in the UE 3. At PLMN change, the UE 3 resets the network slice usage back-off timer, if still running. The network slice usage back-off timer may be associated with the rejected network slice(s) (e.g. S-NSSAI-3).

### Variant 2 of the First Example of the First Aspect

The NSACF 77 may trigger the Nnsacf_NSAC_DeregistrationNotification message to AMF 70 when the number of UEs registered with S-NSSAI-3 has reached a threshold value, e.g. maximum number of UEs registered with S-NSSAI-3. The case where the number of UEs registered with S-NSSAI-3 has reached a threshold value, e.g. maximum number of UEs registered with S-NSSAI-3 may mean the network slice identified by S-NSSAI-3 is overloaded. In this case the rejection cause in the Nnsacf_NSAC_DeregistrationNotification message indicates that the maximum number of UEs registered with a network slice, e.g. S-NSSAI-3 has been reached. The AMF 70 delivers the rejected S-NSSAI-3 and the new reject cause which is set to ‘maximum number of UEs registered with a network slice has been reached’ to the UE 3 in step 9 and the UE 3 removes the rejected network slice, e.g. S-NSSAI-3 from the Allowed NSSAI. The reject cause which is set ‘maximum number of UEs registered with a network slice has been reached’ to may indicate that the maximum number of UEs registered with a network slice, e.g. S-NSSAI-3 has been reached. In addition, the Nnsacf_NSAC_DeregistrationNotification message may include a back-off timer parameter for the rejected network slice, e.g. S-NSSAI-3. The back-off timer parameter may be included in the UCU message or the Deregistration Request message. If the back-off timer parameter is included in the UCU message or the Deregistration Request message by the AMF 70, the UE 3 starts a timer with the value provided in the back-off timer parameter and the UE 3 does not attempt another registration for the rejected network slice, e.g. S-NSSAI-3 while the timer is still running. The UE 3 may attempt another registration for the rejected network slice, e.g. S-NSSAI-3 in a case where the timer expires.

### Variant 3 of the First Example of the First Aspect

In step 9 of FIG. 1, the AMF 70 may provide to the UE 3 a replacement network slice for the rejected S-NSSAI-3 if there is another network slice (e.g. S-NSSAI-4) supported by the AMF 70 and the UE 3 is subscribed to another network slice (e.g. S-NSSAI-4) which can provide the same, similar or alternative service(s) to the rejected S-NSSAI-3. If so, the AMF 70 includes the replacement network slice (e.g. S-NSSAI-4) in the Allowed NSSAI for the UE 3 in step 9 and the UE 3 will end in a state registered for S-NSSAI-1, S-NSSAI-2 and the replacement network slice (e.g. S-NSSAI-4). For example, the AMF 70 may store information indicating the replacement network slice (e.g. S-NSSAI-4). For example, the AMF 70 may store information indicating network slice(s) that the UE 3 is subscribed and that can provide the same, similar or alternative service(s) to the rejected S-NSSAI-3.

### Variant 4 of the First Example of the First Aspect

When UE 3 releases the PDU session(s) on S-NSSAI-1 and S-NSSAI-2 that is established in step 4, the SMF 71 contacts to the NSACF 77 for PDU sessions quota control. For example, the SMF 71 may contact to the NSACF 77 for PDU sessions quota control in a case where the SMF 71 receives, from other nodes (e.g. the UE 3), notification regarding releasing the PDU session(s) on S-NSSAI-1 and S-NSSAI-2.

In this case, the NSACF 77 re-starts the usage control timers for S-NSSAI-1 and S-NSSAI-2 for the UE 3 as associated PDU session(s) are released.

### Variant 5 of the First Example of the First Aspect

In step 2, the Nnsacf_NSAC_NumOfUEsUpdate_Request message may not include the usage control parameter.

For example, the NSACF 77 may understand that network slice(s) identified by S-NSSAI(s) in the Nnsacf_NSAC_NumOfUEsUpdate_Request message is subject to usage control or subject to inactivity control based on inclusion of the S-NSSAI(s) and the usage control timer parameter.

In a case where the NSACF 77 receives the Nnsacf_NSAC_NumOfUEsUpdate_Request message without the usage control parameter in step 2, the NSACF 77 may start the usage control timers for S-NSSAI-1, S-NSSAI-2 and S-NSSAI-3 in step 3 and the subsequent processes may be performed in accordance with the First Example of the First Aspect.

In step 2, the Nnsacf_NSAC_NumOfUEsUpdate_Request message may not include the usage control parameter and the usage control timer parameter.

For example, the NSACF 77 may understand that network slice(s) identified by S-NSSAI(s) in the Nnsacf_NSAC_NumOfUEsUpdate_Request message is subject to usage control or subject to inactivity control based on reception of the Nnsacf_NSAC_NumOfUEsUpdate_Request message.

In a case where the NSACF 77 receives the Nnsacf_NSAC_NumOfUEsUpdate_Request message without the usage control parameter and the usage control timer parameter in step 2, the NSACF 77 may start the usage control timers for S-NSSAI-1, S-NSSAI-2 and S-NSSAI-3 in step 3 and the subsequent processes may be performed in accordance with the First Example of the First Aspect. In this case, the NSACF 77 may configure value of the usage control timer(s) based on local configuration of the NSACF 77 or operator's policy stored in the NSACF 77.

### Second Example of the First Aspect

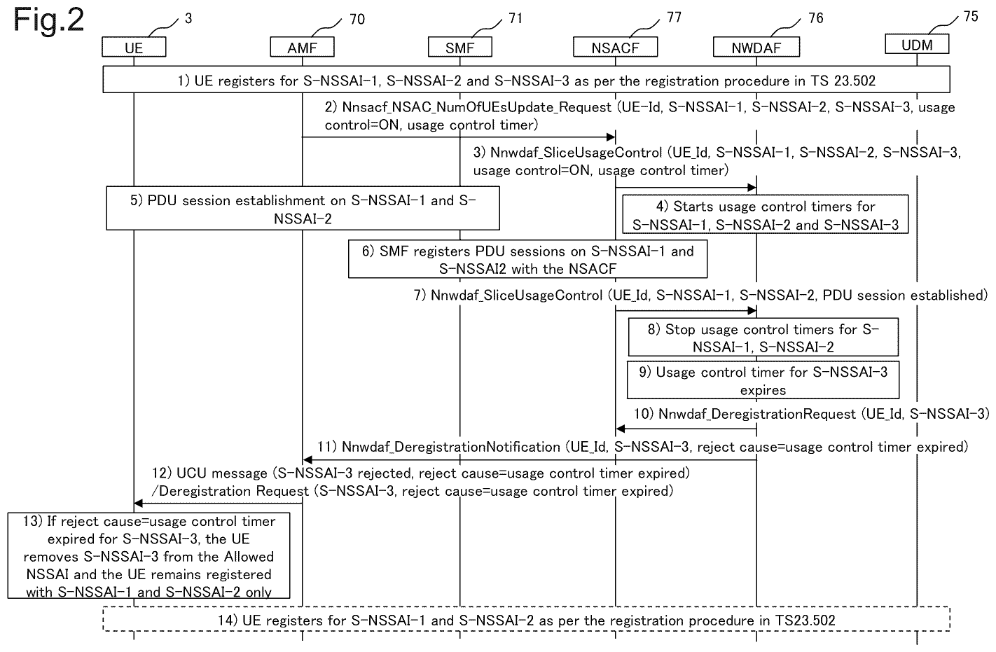

The Second Example of the First Aspect in FIG. 2 discloses a mechanism which enables a network to deregister a UE 3 from a network slice via an NWDAF 76 if the network slice is not used for a long time. For example, the Second Example of the First Aspect in FIG. 2 discloses a mechanism which enables a network to deregister the UE 3 from a network slice via the NWDAF 76 if there is no PDU session(s) established by the UE 3 on the network slice for a duration of time defined by the network operator. For example, the Second Example of the First Aspect in FIG. 2 discloses a mechanism which enables a network to deregister the UE 3 from a network slice via the NWDAF 76 if the number of UE registrations with the network slice has reached a certain threshold, e.g. the maximum number of UEs registered with the network slice. For example, the Second Example of the First Aspect in FIG. 2 discloses a mechanism which enables a network to deregister the UE 3 from a network slice via the NWDAF 76 if the network slice is overloaded. As the NWDAF 76 may interwork with multiple or all NSACF 77 in a PLMN, the NWDAF 76 may make a holistic decision for network slice usage control. For example, if a sum of the number of the UEs registered to a network slice in all NSACF 77 in the PLMN exceeds the maximum number of the UEs allowed to register with the network slice according to the SLA (Service Level Agreement) with a third party, then the NWDAF 76 may take a decision for deregistering a UE e.g. UE 3 from use of the network slice based on the accumulative number of the UEs registered with the network slice via all of the NSACF in the PLMN.
1. A UE 3 registers with an AMF 70 for network slice(s), e.g. network slice(s) which are identified by S-NSSAI-1, S-NSSAI-2 and S-NSSAI-3 and which are supported by the network and by the AMF 70 in the UE 3's location. For example, the UE 3 may perform a registration procedure for S-NSSAI-1, S-NSSAI-2 and S-NSSAI-3 as per NPL 3.
2. If the network slices identified by S-NSSAI-1, S-NSSAI-2 and S-NSSAI-3 are subject to Network Slice Admission Control (NSAC), the AMF 70 registers the UE 3 for each one of these network slices with an NSACF 77 for the purpose of the quota control, i.e. control of the number of the UEs registered with a network slice not to exceed the maximum number of the UEs allowed to register with that network slice. The AMF 70 may find out whether a network slice is subject to NSAC via interacting with a UDM 75 and retrieving UE 3's subscription information along with information whether the network slice is subject to NSAC. For example, the AMF 70 may already have the subscription information for the UE 3 in a UE 3's context within the AMF 70. For example, the AMF 70 may be configured with information about whether a network slice is subject to NSAC or not.

If the requested network slices which are identified by S-NSSAI-1, S-NSSAI-2 and S-NSSAI-3 and which are requested by the UE 3 are subject to NSAC, the AMF 70 registers the UE 3 for these network slices by sending an Nnsacf_NSAC_NumOfUEsUpdate_Request message to the NSACF 77. The AMF 70 includes in the message the UE 3's identity (e.g. UE-Id), S-NSSAI-1, S-NSSAI-2, S-NSSAI-3 which identify the requested network slices and a parameter called ‘usage control’ set to ON or ‘inactivity control’ set to ON or any other notation for a parameter in order to indicate to the NSACF 77 that the network slice(s) is subject to usage control or inactivity control. The ‘usage control’ set to ON or the ‘inactivity control’ set to ON may indicate that the UE 3 is to be deregistered from the network slice if the network slice is not used by the UE 3 for certain time.

The ‘usage control’ or the ‘inactivity control’ or any other notation for a parameter in order to indicate to the NSACF 77 that the network slice(s) is subject to usage control or subject to inactivity control may be collectively expressed as ‘usage control’ or ‘usage control’ parameter.

For example, the ‘usage control’ may be related to S-NSSAI(s) that the UE 3 registers. For example, the ‘usage control’ set to ON may be related to S-NSSAI-1, S-NSSAI-2 and S-NSSAI-3.

The AMF 70 may also include, in the Nnsacf_NSAC_NumOfUEsUpdate_Request message, ‘usage control timer’ parameter or ‘inactivity control timer’ parameter or any other notation for a parameter in order to define a time or time period for which if the network slice(s) is not used by the UE 3, e.g. if no service request or no PDU session is established by the UE 3 on the network slice(s), the UE 3 is to be deregistered from the network slice(s).

The ‘usage control timer’ parameter or the ‘inactivity control timer’ parameter or any other notation for a parameter in order to define a time or time period for which if the network slice(s) is not used by the UE 3, the UE 3 is to be deregistered from the network slice(s) may be collectively expressed as ‘usage control timer’ or ‘usage control timer’ parameter.

For example, the AMF 70 may configure the ‘usage control timer’ parameter based on a local configuration in the AMF 70 or network operator policy within the AMF 70. Alternatively, the ‘usage control timer’ parameter could be configured in the NSACF 77 or the ‘usage control timer’ parameter is based on network operator policy within the NSACF 77. For example, the AMF 70 or the NSACF 77 may determine value of the ‘usage control timer’ parameter.

For example, the ‘usage control timer’ parameter may be related to S-NSSAI(s) that the UE 3 registers. For example, the ‘usage control timer’ may be related to S-NSSAI-1, S-NSSAI-2 and S-NSSAI-3. Value of the ‘usage control timer’ parameter may be same to S-NSSAI-1, S-NSSAI-2 and S-NSSAI-3 or be different for S-NSSAI-1, S-NSSAI-2 and S-NSSAI-3. Value of the ‘usage control timer’ parameter may be expressed as a value associated with S-NSSAI-1, S-NSSAI-2 and S-NSSAI-3.

For example, the AMF 70 may send the Nnsacf_NSAC_NumOfUEsUpdate_Request message during a registration procedure for S-NSSAI-1, S-NSSAI-2 and S-NSSAI-3.
3. The NSACF 77 receives the Nnsacf_NSAC_NumOfUEsUpdate_Request message from the AMF 70.

The NSACF 77 may start the quota control for the network slices provided by the AMF 70, e.g. S-NSSAI-1, S-NSSAI-2 and S-NSSAI-3. For example, the NSACF 77 may start control for the maximum number of the registered UEs for these network slices as per clause 4.2.11 in NPL 3. If the provided network slices, e.g. S-NSSAI-1, S-NSSAI-2, S-NSSAI-3 by the AMF 70 are subject to usage control, e.g. indicated by the AMF 70 via ‘usage control’ parameter set to ON or indicated by a configuration in the NSACF 77 (e.g. if the NSACF 77 receives the ‘usage control’ parameter set to ON or indicated by a configuration in the NSACF 77), the NSACF 77 sends an Nnwdaf_SliceUsageControl message including UE_Id, S-NSSAI-1, S-NSSAI-2, S-NSSAI-3, usage control which is set to ON and usage control timer to the NWDAF 76. For example, the NWDAF 76 analyzes the usage of the network slices per UE, e.g. UE 3 or per multiple UEs based on inputs from one or multiple NSACFs and other network functions as AMF, e.g. AMF 70 and SMF, e.g. SMF 71, for example. For example, the NWDAF 76 analyzes data related to a network based on other factors to the network slice, for example, network slice congestion. The NSACF 77 may include in the Nnwdaf_SliceUsageControl message parameters mentioned below:
UE-Id-identity of the UE 3 subject to usage control;
One or more network slices—e.g. S-NSSAI-1, S-NSSAI-2, S-NSSAI-3 which are subject to usage control;
Usage control parameter set to ON in order to indicate that the included network slice(s) (e.g. S-NSSAI-1, S-NSSAI-2, and S-NSSAI-3) is subject to usage control. The usage control parameter may be one per network slice or one for multiple network slices;
Usage control timer—a time value to indicate duration for which the UE 3 can stay registered for the network slice without using the network slice, i.e. without requesting service on the network slice or without establishing PDU session on the network slice. The usage control timer may be same to the ‘usage control timer’ parameter received from the AMF 70. The usage control timer may be configured within the NSACF 77 or be based on the operator policy in the NSACF 77. For example, the NSACF 77 may determine value of the usage control timer based on the operator policy or local configuration in the NSACF 77. For example, the usage control timer may indicate a time or time period for which if the network slice(s) is not used by the UE 3, e.g. if no service request or no PDU session is established by the UE 3 on the network slice(s), the UE 3 is to be deregistered from the network slice(s).

For example, the NSACF 77 may send, to the NWDAF 76, a message related to a network slice. For example, the NSACF 77 may send, to the NWDAF 76, a message related to management of a network slice. For example, the NSACF 77 may send, to the NWDAF 76, a message related to management of a number of UE(s) registered with a network slice.
4. The NWDAF 76 receives the Nnwdaf_SliceUsageControl message from the NSACF 77.

If the network slice for which the UE 3 registers for is subject to usage or inactivity control, e.g. if the ‘usage control’ parameter from the NSACF 77 in the Nnwdaf_SliceUsageControl message is set to ON, the NWDAF 76 starts a timer which measures time for which a network slice has not been used by the UE 3, e.g. for which no service is requested or no PDU session is established by the UE 3 on that network slice or no data was exchanged on an established PDU session. The timer may be called as, for example, ‘usage control timer’ or ‘inactivity control timer’ or any other notation for a timer. The ‘usage control timer’ or the ‘inactivity control timer’ or any other notation for a timer may be collectively expressed as ‘usage control timer’.

The ‘usage control timer’ or ‘the ‘inactivity control timer’ may be set to a value configured in the NWDAF 76 by the operator. The ‘usage control timer’ may be configured within the NWDAF 76 or be based on the operator policy in the NWDAF 76. For example, the NWDAF 76 may determine value of the ‘usage control timer’ timer based on the operator policy or local configuration in the NWDAF 76. The ‘usage control timer’ or ‘the ‘inactivity control timer’ may be set to a value indicated by the AMF 70 in the ‘usage control timer’ parameter or ‘inactivity control timer’ parameter. The ‘usage control timer’ or ‘the ‘inactivity control timer’ may be set to a value indicated by the NSACF 77 in the usage control timer. The NWDAF 76 runs the ‘usage control timer’ for each network slice which is subject to usage control, e.g. a network slice for which the ‘usage control’ parameter is set to ON. For example, the NWDAF 76 runs the ‘usage control timers’ for at least one of S-NSSAI-1, S-NSSAI-2 and S-NSSAI-3. The ‘usage control timer’ may be controlled per UE by the NWDAF 76. For example, the NWDAF 76 may control the ‘usage control timer’ per UE identified by the UE-Id. For example, the NWDAF 76 may run the ‘usage control timers’ regarding at least one of S-NSSAI-1, S-NSSAI-2 and S-NSSAI-3 for the UE 3.
5. At some stage of the UE 3 that has an Allowed NSSAI including S-NSSAI-1, S-NSSAI-2 and S-NSSAI-3, the UE 3 requests a service or PDU session establishment with S-NSSAI-1 and S-NSSAI-2, for example.
6. An SMF 71 registers PDU session(s) established on S-NSSAI-1 and S-NSSAI-2 with the NSACF 77 for the maximum number of PDU sessions quota control. For example, the NSACF 77 detects an activity related to a network slice (e.g. a network slice identified by S-NSSAT-1 or S-NSSAT-2). For example, the SMF 71 may send, to the NSACF 77, a message to register the PDU session(s) established on S-NSSAI-1 and S-NSSAI-2. The message may be expressed as registration notification.
7. The NSACF 77 sends an Nnwdaf_SliceUsageControl message including UE_Id, S-NSSAI-1, S-NSSAI-2, S-NSSAI-3, PDU session established to the NWDAF 76. For example, the NWDAF 76 analyzes the usage of the network slices per UE, e.g. UE 3 or per multiple UEs based on inputs from one or multiple NSACFs and other network functions as AMF, e.g. AMF 70 and SMF, e.g. SMF 71, for example. The NSACF 77 may include in the Nnwdaf_SliceUsageControl message parameters mentioned below:
   UE-Id-identity of the UE 3 subject to usage control;
   One or more network slices parameter—e.g. S-NSSAI-1, S-NSSAI-2, S-NSSAI-3 which are subject to usage control. For example, one or more network slices parameter may indicate network slice(s) that PDU session(s) has been established. For example, in a case where the NSACF 77 receives, from the SMF 71 in step 6, information indicating that the PDU session(s) is established on network slices identified by S-NSSAI-1 and S-NSSAI-2, the NSACF 77 may set the one or more network slices parameter to S-NSSAI-1 and S-NSSAI-2. The one or more network slices parameter may be expressed as a parameter related to one or more network slices;
   “PDU session established” parameter—indicates to the NWDAF 76 that PDU session(s) that is related to the associated network slice(s) in the one or more network slices parameter in this message has been established. For example, in a case where the NSACF 77 set the one or more network slices parameter to S-NSSAI-1 and S-NSSAI-2, the NSACF 77 may set the “PDU session established” parameter to indicate that PDU session(s) related to S-NSSAI-1 and S-NSSAI-2 has been established. The “PDU session established” parameter may be expressed as an established PDU session parameter.

For example, the NSACF 77 may send, to the NWDAF 76, a message related to a network slice. For example, the NSACF 77 may send, to the NWDAF 76, a message related to management of a network slice. For example, the NSACF 77 may send, to the NWDAF 76, a message related to management of a number of UE(s) registered with a network slice. For example, the NSACF 77 may send, to the NWDAF 76, a message related to PDU session(s). For example, the NSACF 77 may send, to the NWDAF 76, a message indicating PDU session(s) has been established. For example, the NSACF 77 may send, to the NWDAF 76, a message indicating PDU session(s) related to at least one of the S-NSSAI-1 and S-NSSAI-2 has been established. For example, the NWDAF 76 detects an activity related to a network slice (e.g. an activity related to a network slice identified by S-NSSAI-1 or S-NSSAI-2).
8. The NWDAF 76 receives the Nnwdaf_SliceUsageControl message from the NSACF 77. If network slices identified by S-NSSAI-1 and S-NSSAI-2 are subject to usage control, i.e. if the NWDAF 76 has active usage control timers running for the UE 3 for S-NSSAI-1 and S-NSSAI-2, the NWDAF 76 stops the ‘usage control timer’ for S-NSSAI-1 and the ‘usage control timer’ for S-NSSAI-2 as these two network slices have been used i.e. the PDU session(s) is established, by the UE 3, on network slices identified by S-NSSAI-1 and S-NSSAI-2 before their usage control timers expired. For example, in a case where the NWDAF 76 receives the Nnwdaf_SliceUsageControl message from the NSACF 77, the NWDAF 76 may stop the usage control timers for S-NSSAI-1 and S-NSSAI-2 which start in step 4. For example, in a case where the NWDAF 76 receives the Nnwdaf_SliceUsageControl message from the NSACF 77 in step 7, the NWDAF 76 may recognize, based on at least one of the parameters in the Nnwdaf_SliceUsageControl message, that the network slices identified by S-NSSAI-1 and S-NSSAI-2 have been used i.e. the PDU session(s) is established, by the UE 3, on network slices identified by S-NSSAI-1 and S-NSSAI-2, and the NWDAF 76 may stop the usage control timers for S-NSSAI-1 and S-NSSAI-2 which start in step 4. For example, the NWDAF 76 may recognize that the network slices identified by S-NSSAI-1 and S-NSSAI-2 have been used i.e. the PDU session(s) is established, by the UE 3, on network slices identified by S-NSSAI-1 and S-NSSAI-2 by using at least one of the one or more network slices parameter and the “PDU session established” parameter. For example, in a case where the NWDAF 76 receives a message indicating an activity related to the network slice identified by S-NSSAI-1 or S-NSSAI-2, the NWDAF 76 may stop the usage control timers for S-NSSAI-1 and S-NSSAI-2 which start in step 4. For example, the NWDAF 76 may detect an activity related to the network slice (e.g. a network slice identified by S-NSSAI-1 or S-NSSAI-2). For example, upon receiving a message from the NSACF 77, the NWDAF 76 may detect an activity related to the network slice (e.g. a network slice identified by S-NSSAI-1 or S-NSSAI-2).

When the UE 3 stops using network slices identified by S-NSSAI-1 and S-NSSAI-2, i.e. the UE 3 releases the PDU session(s) on S-NSSAI-1 and S-NSSAI-2, the NWDAF 76 re-starts the usage control timers for S-NSSAI-1 and S-NSSAI-2. For example, in a case where the NSACF 77 receives release notification for the PDU session(s) on S-NSSAI-1 and S-NSSAI-2 from the SMF 71, the NSACF 77 may send the release notification to the NWDAF 76. In a case where the NWDAF 76 receives the release notification, the NWDAF 76 may re-start the usage control timers for S-NSSAI-1 and S-NSSAI-2. The release notification may be an Nnwdaf_SliceUsageControl message. The Nnwdaf_SliceUsageControl message in case of informing the release of the PDU session(s) may include UE-Id (e.g. identity of the UE 3), one or more network slices parameter and “PDU session released” parameter. The one or more network slices parameter may indicate that network slice(s) that PDU session(s) has been released (e.g. network slice identity related to released PDU session(s). e.g. S-NSSAI-1 and S-NSSAI-2). The “PDU session released” parameter may indicate that PDU session(s) that is related to the associated network slice(s) (e.g. network slices identified by S-NSSAI-1 and S-NSSAI-2) has been released. The PDU session released parameter may indicate that PDU session(s) related to S-NSSAI-1 and S-NSSAI-2 has been established.
9. The ‘usage control timer’ for S-NSSAI-3 for the UE 3 expires. As the UE 3 has not used S-NSSAI-3, i.e. the UE 3 has not requested service or has not established a PDU session on S-NSSAI-3 for some time, the ‘usage control timer’ for the UE 3 for S-NSSAI-3 expires. For example, the NWDAF 76 may detect the usage control timer for S-NSSAI-3 for the UE 3 expires.
10. The NWDAF 76 sends an Nnwdaf_DeregistrationRequest message including UE_Id and S-NSSAI-3 to the NSACF 77 where the quota control takes place for a network slice identified by S-NSSAI-3 as per clause 4.2.11 in NPL 3, i.e. so that the NSACF 77 can deregister the UE 3 from S-NSSAI-3, reduce the number of UEs registered with S-NSSAI-3 by 1 and remove the UE 3's identity from a list of UEs registered with S-NSSAI-3. The UE_Id may be identity of the UE 3. In a case where the NSACF 77 receives the Nnwdaf_DeregistrationRequest message, the NSACF 77 updates the number of the UEs registered with S-NSSAI-3 by decreasing the number of the registered UEs with S-NSSAI-3 by 1 and also the NSACF 77 removes the UE 3's identity, e.g. the UE-Id from the list of the UEs registered with S-NSSAI-3. For example, the NWDAF 76 sends the Nnwdaf_DeregistrationRequest message in a case where the ‘usage control timer’ for S-NSSAI-3 for the UE 3 expires. The Nnwdaf_DeregistrationRequest message may include network slice identity for which the ‘usage control timer’ for the UE 3 expired. In a case where the ‘usage control timer’ for the UE 3 for S-NSSAI-3 expires, the NWDAF 76 may include, in the Nnwdaf_DeregistrationRequest message, S-NSSAI-3 as the network slice identity for which the ‘usage control timer’ for the UE 3 expired.

The Nnwdaf_DeregistrationRequest message may be sent for the NSACD 77.
11. The NWDAF 76 also may send an Nnwdaf_DeregistrationNotification message including UE_Id and S-NSSAI-3, reject cause which is set to ‘usage control timer expired’ to the AMF 70 to indicate that the UE 3 is to be deregistered from a network slice identified by S-NSSAI-3 as the UE 3 has not used S-NSSAI-3 until the expiry of the ‘usage control timer’ for S-NSSAI-3 for UE 3. For example, after the step 8 or step 9, the NWDAF 76 may send, to the AMF 70, a message indicating a network slice (e.g. a network slice identified by S-NSSAI-3) is not used. The NWDAF 76 may include in the Nnwdaf_DeregistrationNotification message to the AMF 70 parameters mentioned below:
   UE-Id—identity of the UE 3 that is to be deregistered
   S-NSSAI-3—network slice identity for which the UE 3 is to be deregistered by the NSACF 77, or network slice identity that the UE 3 has not used, or network slice identity for which the ‘usage control timer’ expires.
   Reject cause which is set to ‘usage control timer expired’—This reject cause indicates reason for the UE 3 deregistration from S-NSSAI-3. For example, the reject cause may indicate that the UE 3 has not requested service or has not established a PDU session on a network slice identified by S-NSSAI-3 until the expiry of the ‘usage control timer’ for the UE 3. The reject cause may be associated with S-NSSAI-3. The reject cause may indicate that the UE 3 does not use a network slice which is identified S-NSSAI 3 until the expiry of the ‘usage control timer’ for UE 3. The reject cause may indicate expiry of the ‘usage control timer’.
12. The AMF 70 receives the Nnwdaf_DeregistrationNotification message from the NWDAF 76. Upon receiving the Nnwdaf_DeregistrationNotification message, if the UE 3 is in connected mode, the AMF 70 may deregister the UE 3 for S-NSSAI-3 via a UE Configuration Update message in which the AMF 70 removes S-NSSAI-3 from the Allowed NSSAI and adds S-NSSAI-3 to the Rejected NSSAI for UE 3. The AMF 70 may send the UE Configuration Update message. For example, the UE Configuration Update message may be expressed as UCU message. For example, the AMF 70 may include, in the UCU message, information to instruct the UE 3 to remove S-NSSAI-3 from the Allowed NSSAI and add S-NSSAI 3 to the Rejected NSSAI. For example, in a case where the AMF 70 sends the UCU message, the AMF 70 removes S-NSSAI-3 from the Allowed NSSAI for the UE 3 stored in the AMF 70 and adds S-NSSAI-3 to the Rejected NSSAI for the UE 3 stored in the AMF 70.

The AMF 70 also includes, in the UCU message, a reject cause for S-NSSAI-3, e.g. reject cause which is set to ‘usage control timer expired’ or ‘inactivity control timer expired’ or any other notation for a reject cause in order to indicate that the rejection is due to a network slice not being used by the UE 3 until the expiry of the usage control timer for the UE 3 for that network slice.

Alternatively, the AMF 70 may use existing UE deregistration procedure by sending Deregistration Request to the UE 3 in which the AMF 70 includes the network slice, e.g. S-NSSAI-3 for which the UE 3 is rejected from registration and a reject cause which is set to ‘usage control timer expired’.

Upon receiving the Nnwdaf_DeregistrationNotification message, if the UE 3 is in idle mode, the AMF 70 either:
Pages the UE 3 and after connecting with the UE 3 the AMF 70 sends the UE Configuration Update message to the UE 3 with the rejected S-NSSAI-3 and the reject cause which is set to ‘usage control timer expired’; or
Stores the information from the Nnwdaf_NSAC_DeregistrationNotification message from the NWDAF 76 until when the UE 3 connects back to the network, e.g. for service or PDU session establishment. In a case where the UE 3 connects back to the network, the AMF 70 provides the rejected S-NSSAI-3 and the reject cause which is set to ‘usage control timer expired’ to the UE 3 via the UE Configuration Update message.

The AMF 70 may store information indicating whether the UE 3 is in connected mode or is in idle mode. The AMF 70 may receive information indicating whether the UE 3 is in connected mode or is in idle mode from other network node. The AMF 70 may determine whether the UE 3 is in connected mode or is in idle mode based on the information indicating whether the UE 3 is in connected mode or is in idle mode.
13. If the UE 3 receives a registration rejection for a network slice, e.g. S-NSSAI-3 via the UE Configuration Update message or via the UE Deregistration message with a reject cause which is set to ‘usage control timer expired’, the UE 3 removes the rejected S-NSSAI-3 from the Allowed NSSAI and the UE 3 continues to be registered for S-NSSAI-1 and S-NSSAI-2. The UE 3 may add the rejected S-NSSAI-3 to the Rejected NSSAI.
14. Optionally, the UE 3 may refresh its registration by triggering a new registration procedure for S-NSSAI-1 and S-NSSAI-2 as per a registration procedure in NPL 3.

For example, a communication apparatus corresponding to the NWDAF 76 may receive a first message. The first message may include Single Network Slice Selection Assistance Information (S-NSSAI). The communication apparatus may start a timer for the S-NSSAI after receiving the first message. The timer may be set to a value associated with the S-NSSAI. The communication apparatus may send a second message for Network Slice Admission Control (NSAC) and a third message in a case where the timer expires. The second message may include the S-NSSAI. The third message may include the S-NSSAI and a reject cause indicating expiry of the timer.

For example, a first core network apparatus corresponding to the NWDAF 76 may receive, from a second core network apparatus corresponding to NSACF 77, a message related to management of a network slice. The first core network apparatus may analyse data related to the network slice based on information from other core network apparatus corresponding to at least one of the second core network apparatus, the AMF 70 and the SMF 71. The first core network apparatus may start a timer for the network slice after receiving the message. The first core network apparatus may detect the timer is expired. The first core network apparatus may send, to the second core network apparatus, a message indicating at least one of the timer is expired or the network slice related to the timer is not used, after the detecting the timer is expired. The second core network apparatus may manage network slice admission control.

For example, a first core network apparatus corresponding to the NWDAF 76 may receive, from a second core network apparatus corresponding to NSACF 77, a message related to management of a network slice. The first core network apparatus may analyse data related to the network slice based on information from other network apparatus corresponding to at least one of the second core network apparatus, the AMF 70 and the SMF 71. The first core network apparatus may start a timer for the network slice after receiving the message. The first core network apparatus may detect an activity related to the network slice. The first core network apparatus may stop the timer after detecting the activity. The second core network apparatus may manage network slice admission control.

According to the above, the above problem such as whether and how to enhance the system to ensure network-controlled behavior of network slice usage including UE registration and PDU Session establishment can be solved.

### Variant 1 of the Second Example of the First Aspect

In step 11 of FIG. 2, the NWDAF 76 may include a network slice usage back-off timer in the Nnwdaf_NSAC_DeregistrationNotification message to the AMF 70. If the network slice usage back-off timer is included by the NWDAF 76, the AMF 70 relays the network slice usage back-off timer to the UE 3 in step 12. If the UE 3 receives rejection for a network slice (e.g. S-NSSAI-3) with reject cause which is set to ‘usage control timer expired’ and the network slice usage back-off timer, the UE 3 starts the network slice usage back-off timer and the UE 3 does not request registration for the rejected network slice, e.g. S-NSSAI-3, while the network slice usage back-off timer for S-NSSAI-3 is running. The UE 3 may request registration for the rejected network slice, e.g. S-NSSAI-3 in a case where the network slice usage back-off timer for S-NSSAI-3 expires. Cell re-selection and registration area updates by the UE 3 do not reset the network slice usage back-off timer in the UE 3. At PLMN change, the UE 3 resets the network slice usage back-off timer, if still running. The network slice usage back-off timer may be associated with the rejected network slice(s) (e.g. S-NSSAI-3).

### Variant 2 of the Second Example of the First Aspect

The NWDAF 76 may trigger the Nnwdaf_NSAC_DeregistrationNotification message to AMF 70 when the number of UEs registered with S-NSSAI-3 has reached a threshold value, e.g. maximum number of UEs registered with S-NSSAI-3. The case where the number of UEs registered with S-NSSAI-3 has reached a threshold value, e.g. maximum number of UEs registered with S-NSSAI-3 may mean the network slice identified by S-NSSAI-3 is overloaded. For example, this may be indicated to the NWDAF 76 from the NSACF 77 via an Nnsacf_MaxRegisteredUEs message including S-NSSAI-3 or any other notation for a message from the NSACF 77 to the NWDAF 76 with a purpose to indicate that the number of the registered UEs with a network slice, e.g. S-NSSAI-3, has reached its maximum. In this case the rejection cause in the Nnwdaf_NSAC_DeregistrationNotification message indicates that the maximum number of UEs registered with a network slice, e.g. S-NSSAI-3 has been reached. The AMF 70 delivers the rejected S-NSSAI-3 and the new reject cause which is set to ‘maximum number of UEs registered with a network slice has been reached’ to the UE 3 in step 12 and the UE 3 removes the rejected network slice, e.g. S-NSSAI-3 from the Allowed NSSAI. The reject cause which is set ‘maximum number of UEs registered with a network slice has been reached’ to may indicate that the maximum number of UEs registered with a network slice, e.g. S-NSSAI-3 has been reached. In addition, the Nnwdaf_NSAC_DeregistrationNotification message may include a back-off timer parameter for the rejected network slice, e.g. S-NSSAI-3. If the back-off timer parameter is included in the UCU message or the Deregistration Request message by the AMF 70, the UE 3 starts a timer with the value provided in the back-off timer parameter and the UE 3 does not attempt another registration for the rejected network slice, e.g. S-NSSAI-3 while the timer is still running. The UE 3 may attempt another registration for the rejected network slice, e.g. S-NSSAI-3 in a case where the timer expires.

### Variant 3 of the Second Example of the First Aspect

In step 12 of FIG. 2, the AMF 70 may provide to the UE 3 a replacement network slice for the rejected S-NSSAI-3 if there is another network slice (e.g. S-NSSAI-4) supported by the AMF 70 and the UE 3 is subscribed to another network slice (e.g. S-NSSAI-4) which can provide the same, similar or alternative service(s) to the rejected S-NSSAI-3. If so, the AMF 70 includes the replacement network slice (e.g. S-NSSAI-4) in the Allowed NSSAI for the UE 3 in step 12 and the UE 3 will end in a state registered for S-NSSAI-1, S-NSSAI-2 and the replacement network slice (e.g. S-NSSAI-4). For example, the AMF 70 may store information indicating the replacement network slice (e.g. S-NSSAI-4). For example, the AMF 70 may store information indicating network slice(s) that the UE 3 is subscribed and that can provide the same, similar or alternative service(s) to the rejected S-NSSAI-3.

### Variant 4 of the Second Example of the First Aspect

When UE 3 releases the PDU session(s) on S-NSSAI-1 and S-NSSAI-2 that is established in step 5, the SMF 71 contacts to the NWDAF 76 for Slice Usage Notification. For example, the SMF 71 may contact to the NWDAF 76 for Slice Usage Notification in a case where the SMF 71 receives, from other nodes (e.g. the UE 3), notification regarding releasing the PDU session(s) on S-NSSAI-1 and S-NSSAI-2.

In this case, the NWDAF 76 re-starts the usage control timers for S-NSSAI-1 and S-NSSAI-2 for the UE 3 as associated PDU session(s) are released.

### Variant 5 of the Second Example of the First Aspect

In step 2, the Nnsacf_NSAC_NumOfUEsUpdate_Request message may not include the usage control parameter.

For example, the NSACF 77 may understand that network slice(s) identified by S-NSSAI(s) in the Nnsacf_NSAC_NumOfUEsUpdate_Request message is subject to usage control or subject to inactivity control based on inclusion of the S-NSSAI(s) and the usage control timer parameter.

In a case where the NSACF 77 receives the Nnsacf_NSAC_NumOfUEsUpdate_Request message without the usage control parameter in step 2, the NSACF 77 may send, to the NWDAF 76, the Nnwdaf_SliceUsageControl message without the usage control parameter in step 3. Then the NWDAF 76 may start the usage control timers for S-NSSAI-1, S-NSSAI-2 and S-NSSAI-3 in step 4 and the subsequent processes may be performed in accordance with the Second Example of the First Aspect.

In step 2, the Nnsacf_NSAC_NumOfUEsUpdate_Request message may not include the usage control parameter and the usage control timer parameter.

For example, the NSACF 77 may understand that network slice(s) identified by S-NSSAI(s) in the Nnsacf_NSAC_NumOfUEsUpdate_Request message is subject to usage control or subject to inactivity control based on reception of the Nnsacf_NSAC_NumOfUEsUpdate_Request message.

For example, the NWDAF 76 may understand that network slice(s) identified by S-NSSAI(s) in the Nnwdaf_SliceUsageControl message is subject to usage control or subject to inactivity control based on reception of the Nnwdaf_SliceUsageControl message.

In a case where the NSACF 77 receives the Nnsacf_NSAC_NumOfUEsUpdate_Request message without the usage control parameter and the usage control timer parameter in step 2, the NSACF 77 may send, to the NWDAF 76, the Nnwdaf_SliceUsageControl message without the usage control parameter and the usage control timer parameter in step 3. Then the NWDAF 76 may start the usage control timers for S-NSSAI-1, S-NSSAI-2 and S-NSSAI-3 in step 4 and the subsequent processes may be performed in accordance with the Second Example of the First Aspect. In this case, the NWDAF 76 may configure value of the usage control timer(s) based on local configuration of the NWDAF 76 or operator's policy stored in the NWDAF 76.

In another example, in a case where the NSACF 77 receives the Nnsacf_NSAC_NumOfUEsUpdate_Request message without the usage control parameter and the usage control timer parameter in step 2, the NSACF 77 may configure value of the usage control timer(s) based on local configuration of the NSACF 77 or operator's policy stored in the NSACF 77 and send the Nnwdaf_SliceUsageControl message including the value of the usage control timer(s) to the NWDAF 76.

### Variant 6 of the Second Example of the First Aspect

The NWDAF 76 may send two messages, the Nnwdaf_NSAC_DeregistrationRequest message (or the Nnwdaf_DeregistrationRequest message) and the Nnwdaf_NSAC_DeregistrationNotification message to the NSACF 77 and AMF 70 respectively, when the NWDAF 76 detects that S-NSSAI becomes congested (e.g. in a case where the number of UEs registered with the S-NSSAI which identifies a congested network slice has reached a threshold value, e.g. maximum number of UEs registered with the S-NSSAI). The S-NSSAI which identifies the congested network slice may be expressed as congested S-NSSAI. In this case, the NWDAF 76 sends multiple two messages to multiple NSACFs 77 including the congested S-NSSAI and registered UE IDs to the congested S-NSSAI and reject cause indicating that network slice congested.

Once the NSACF 77 (e.g. each of NSACFs 77) receives the Nnwdaf_NSAC_DeregistrationRequest message that includes multiple UE IDs, then the NSACF 77 may deregister all indicated UEs for indicated network slice by the congested S-NSSAI and may reduce the number of UEs registered with the congested S-NSSAI by the number of the indicated UEs for the congested S-NSSAI.

Once the AMF 70 receives the Nnwdaf_NSAC_DeregistrationNotification message that includes multiple UE IDs, then the AMF 70 performs the UE Configuration Update procedure as described in step 12 for all UEs included in the received Nnwdaf_NSAC_DeregistrationNotification message with reject cause indicating that network slice congested.

### Variant 7 of the Second Example of the First Aspect

The NWDAF 76 may not send the Nnwdaf_NSAC_DeregistrationNotification message (or the Nnwdaf_DeregistrationRequest message) to AMF 70 as described in step 11. In this case, upon reception of the Nnwdaf_NSAC_DeregistrationRequest message (or the Nnwdaf_DeregistrationRequest message) in the NSACF 77, the NSACF 77 sends the Nnsacf_NSAC_DeregistrationNotification message to associated AMF(s) as described in the step 8 in the first Example of the First Aspect for all UEs included in the received Nnwdaf_NSAC_DeregistrationRequest message (or the Nnwdaf_DeregistrationRequest message) with reject cause indicating that network slice congested or usage control timer expired.

### Variant 8 of the Second Example of the First Aspect

The NWDAF 76 may be another NSACF from the NSACF 77. Another NSACF may reside in the PLMN or another HPLMN. In this case the following message name changes apply:
Nnwdaf_SliceUsageControl message in steps 3 and 7 can be replaced with Nnsacf_NSAC_NumOfUEsUpdate_Request message or other message for NSACF service.
Nnwdaf_DeregistrationRequest message in step 10 can be replaced with Nnsacf_DeregistrationRequest message or other message for NSACF service.
Nnwdaf_DeregistrationNotification message in step 11 can be replaced with Nnsacf_DeregistrationNotification message or other message for NSACF service.

### Third Example of the First Aspect

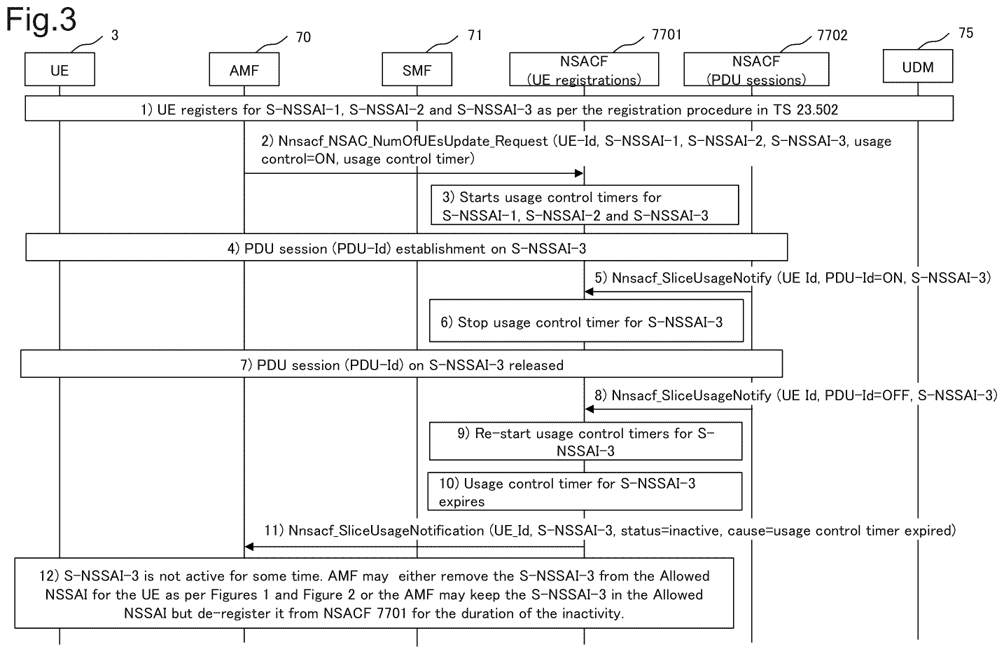

The Third Example of the First Aspect in FIG. 3 discloses a mechanism which enables a network to deregister a UE 3 from a network slice or put the network slice in inactive state when the UE 3 registrations are controlled by an NSACF 7701 and the UE 3's PDU session(s) is controlled by an NSACF 7702, if the network slice is not used for a long time, e.g. no PDU sessions are established by the UE 3 on the network slice for certain duration of time or the PDU session are not active for certain duration of time.
1. A UE 3 registers with an AMF 70 for network slice(s), e.g. network slices which are identified by S-NSSAI-1, S-NSSAI-2 and S-NSSAI-3 and which are supported by a network and by the AMF 70 in the UE 3's location. For example, the UE 3 may perform a registration procedure for S-NSSAI-1, S-NSSAI-2 and S-NSSAI-3 as per NPL 3.
2. If the network slices identified by S-NSSAI-1, S-NSSAI-2 and S-NSSAI-3 are subject to Network Slice Admission Control (NSAC), the AMF 70 registers the UE 3 for each one of these network slices with an NSACF 7701 for the purpose of the quota control, i.e. control of the number of the UEs registered with a network slice not to exceed the maximum number of the UEs allowed to register with that network slice. The NSACF 7701 may control the number of the UEs registered with a network slice not to exceed the maximum number of the UEs allowed to register with that network slice. The AMF 70 may find out whether a network slice is subject to NSAC via interacting with a UDM 75 and retrieving the UE 3's subscription information along with information whether the network slice is subject to NSAC. For example, the AMF 70 may already have the subscription information for the UE 3 in a UE 3's context within the AMF 70. For example, the AMF 70 may be configured with information about whether a network slice is subject to NSAC or not.

If the requested network slices which are identified by S-NSSAI-1, S-NSSAI-2 and S-NSSAI-3 and which are requested by the UE 3 are subject to NSAC, the AMF 70 registers the UE 3 for these network slices by sending an Nnsacf_NSAC_NumOfUEsUpdate_Request message to the NSACF 7701. The AMF 70 includes in the message the UE 3's identity (e.g. UE-Id), S-NSSAI-1, S-NSSAI-2, S-NSSAI-3 which identify the requested network slices and a parameter called ‘usage control’ set to ON or ‘inactivity control’ set to ON or any other notation for a parameter in order to indicate to the NSACF 7701 that the network slice(s) is subject to usage control or inactivity control. The ‘usage control’ set to ON or the ‘inactivity control’ set to ON may indicate that the UE 3 is to be deregistered from the network slice if the network slice is not used by the UE 3 for certain time.

The ‘usage control’ or the ‘inactivity control’ or any other notation for a parameter in order to indicate to the NSACF 77 that the network slice(s) is subject to usage control or subject to inactivity control may be collectively expressed as ‘usage control’ or ‘usage control’ parameter.

For example, the ‘usage control’ may be related to S-NSSAI(s) that the UE 3 registers. For example, the ‘usage control’ set to ON may be related to S-NSSAI-1, S-NSSAI-2 and S-NSSAI-3.

The AMF 70 may also include, in the Nnsacf_NSAC_NumOfUEsUpdate_Request message, ‘usage control timer’ parameter or ‘inactivity control timer’ parameter or any other notation for a parameter in order to define a time or time period for which if the network slice(s) is not used by the UE 3, e.g. if no service request or no PDU session is established by the UE 3 on the network slice(s), the UE 3 is to be deregistered from the network slice(s).

The ‘usage control timer’ parameter or the ‘inactivity control timer’ parameter or any other notation for a parameter in order to define a time or time period for which if the network slice(s) is not used by the UE 3, the UE 3 is to be deregistered from the network slice(s) may be collectively expressed as ‘usage control timer’ or ‘usage control timer’ parameter.

For example, the AMF 70 may configure the ‘usage control timer’ parameter based on a local configuration in the AMF 70 or network operator policy within the AMF 70. Alternatively, the ‘usage control timer’ parameter could be configured in the NSACF 7701 or the ‘usage control timer’ parameter is based on network operator policy within the NSACF 7701. For example, the AMF 70 or the NSACF 7701 may determine value of the ‘usage control timer’ parameter.

For example, the ‘usage control timer’ parameter may be related to S-NSSAI(s) that the UE 3 registers. For example, the ‘usage control timer’ may be related to S-NSSAI-1, S-NSSAI-2 and S-NSSAI-3. Value of the ‘usage control timer’ parameter may be same to S-NSSAI-1, S-NSSAI-2 and S-NSSAI-3 or be different for S-NSSAI-1, S-NSSAI-2 and S-NSSAI-3. Value of the ‘usage control timer’ parameter may be expressed as a value associated with S-NSSAI-1, S-NSSAI-2 and S-NSSAI-3.

For example, the AMF 70 may send the Nnsacf_NSAC_NumOfUEsUpdate_Request message during a registration procedure for S-NSSAI-1, S-NSSAI-2 and S-NSSAI-3. For example, the AMF 70 may send, to the NSACF 7701, a message related to a network slice. For example, the AMF 70 may send, to NSACF 7701, a message related to management of a network slice. For example, the AMF 70 may send, to the NSACF 7701, a message related to management of a number of UE(s) registered with a network slice.
3. The NSACF 7701 receives the Nnsacf_NSAC_NumOfUEsUpdate_Request message from the AMF 70.

If the network slice for which the UE 3 registers for is subject to usage control or inactivity control, e.g. the ‘usage control’ parameter from the AMF 70 is set to ON, the NSACF 7701 starts a timer which measures time for which a network slice has not been used by the UE 3, e.g. for which no service is requested or no PDU session is established by the UE 3 on that network slice or no data was exchanged on an established PDU session. The timer may be called as, for example, ‘usage control timer’ or ‘inactivity control timer’ or any other notation for a timer. The ‘usage control timer’ or the ‘inactivity control timer’ or any other notation for a timer may be collectively expressed as ‘usage control timer’.

The ‘usage control timer’ or ‘the ‘inactivity control timer’ may be set to a value configured in the NSACF 7701 by the operator. The ‘usage control timer’ or ‘the ‘inactivity control timer’ may be set to a value indicated by the AMF 70 in the ‘usage control timer’ parameter or the ‘inactivity control timer’ parameter.

The NSACF 7701 runs a the ‘usage control timer’ for each network slice which is subject to usage control, e.g. a network slice for which the ‘usage control’ parameter is set to ON. For example, the NSACF 7701 runs the ‘usage control timers’ for at least one of S-NSSAI-1, S-NSSAI-2 and S-NSSAI-3. The ‘usage control timer’ may be controlled per UE by the NSACF 7701. For example, the NSACF 7701 may control the ‘usage control timer’ per UE identified by the UE-Id. For example, the NSACF 7701 may run the ‘usage control timers’ regarding at least one of S-NSSAI-1, S-NSSAI-2 and S-NSSAI-3 for the UE 3.
4. At some stage of the UE 3 that has an Allowed NSSAI including S-NSSAI-1, S-NSSAI-2 and S-NSSAI-3, the UE 3 requests a PDU session establishment on S-NSSAI-3, for example. The PDU session on S-NSSAI-3 is registered with an NSACF 7702 which is designated for the number of PDU Sessions per network slice quota control as per clause 4.2.11 of NPL 3. For example, the NSACF 7702 may control the number of PDU Sessions per network slice quota control as per clause 4.2.11 of NPL 3. For example, the NSACF 7702 detects an activity related to a network slice (e.g. a network slice identified by S-NSSAI-3).
5. The NSACF 7702 notifies the NSACF 7701 about the established PDU session on S-NSSAI-3 via an Nnsacf_SliceUsageNotify message. The NSACF 7702 includes, in the Nnsacf_SliceUsageNotify message, UE Id, PDU-Id with value which is set to ON and network slice identity on which there is an active PDU session.

For example, the UE-Id may be UE 3's identity.

For example, the PDU-Id may be identity of an active PDU session on a network slice.

The identity of an active PDU session may be expressed as an active PDU session identity.

For example, the PDU-Id may be active PDU session identity on a network slice.

For example, the PDU-Id may be active PDU session identity on a network slice identified by the network slice identity.

For example, the PDU-Id may be active PDU session identity on a network slice identified by S-NSSAI-3.

For example, the PDU-Id with value which is set to ON may mean that a PDU session identified by the PDU-Id is active on a network slice identified by the network slice identity.

For example, the PDU-Id with value which is set to ON may mean that a PDU session identified by the PDU-Id is active on a network slice identified by S-NSSAI-3.

For example, the network slice identity on which there is an active PDU session may be S-NSSAI-3. For example, in a case where the NSACF 7702 receives a message indicating an activity related to the network slice identified by S-NSSAI-3, the NSACF 7702 may send, to the NSACF 7701, a message indicating detection of an activity related to the network slice identified by S-NSSAI-3.

“the PDU-Id with value which is set to ON” may be expressed as “PDU-Id=ON”.

The Nnsacf_SliceUsageNotify message may be expressed as a message related to establishment of PDU session(s) for S-NSSAI-3.
6. The NSACF 7701 receives the Nnsacf_SliceUsageNotify message from the NSACF 7702. If the NSACF 7701 has an active usage control timer running for the UE 3 for S-NSSAI-3, the NSACF 7701 stops the ‘usage control timer’ for S-NSSAI-3. For example, in a case where the Nnsacf_SliceUsageNotify message includes PDU-Id with value which is set to ON and S-NSSAI-3, the NSACF 7701 may determine that there is an active PDU session identified by the PDU-Id on a network slice identified by S-NSSAI-3. In this case, if the NSACF 7701 starts the usage control timer for S-NSSAI-3 in step 3, the NSACF 7701 may stop the usage control timer for S-NSSAI-3. For example, the NSACF 7701 stops the usage control timer for S-NSSAI-3 which starts in step 3 in a case where the NSACF 7701 receives, from the NSACF 7702, a message indicating detection of an activity related to the network slice identified by S-NSSAI-3.
7. At some stage the UE 3 requests a PDU session release on S-NSSAI-3, for example. The PDU session on S-NSSAI-3 is de-registered with NSACF 7702 which is designated for the number of PDU Sessions established on a network slice quota control as per clause 4.2.11 of NPL 3. For example, the UE 3 request to release the PDU session identified by the PDU-Id activated on the network slice identified by S-NSSAI-3.
8. The NSACF 7702 receives, from other network node (e.g. the SMF 71), notification that the PDU session which is identified by the PDU-Id and which is activated on the network slice identified by S-NSSAI-3 is released. In this case, the NSACF 7702 notifies the NSACF 7701 about the release of the PDU session on S-NSSAI-3 via an Nnsacf_SliceUsageNotify message. The NSACF 7702 includes, in the Nnsacf_SliceUsageNotify message, UE Id, PDU-Id with value which is set to OFF and network slice identity regarding the released PDU session.

For example, the UE-Id may be UE 3's identity.

For example, the PDU-Id may be identity of a released PDU session on a network slice.

The identity of a released PDU session may be expressed as released PDU session identity.

For example, the PDU-Id may be released PDU session identity on a network slice.

For example, the PDU-Id may be released PDU session identity on a network slice identified by the network slice identity.

For example, the PDU-Id may be released PDU session identity on a network slice identified by S-NSSAI-3.

For example, the PDU-Id with value which is set to OFF may mean that a PDU session identified by the PDU-Id is released on a network slice identified by the network slice identity.

For example, the PDU-Id with value which is set to OFF may mean that a PDU session identified by the PDU-Id is released on a network slice identified by S-NSSAI-3.

For example, the network slice identity regarding the released PDU session may be network slice identity of a network slice that there was the active PDU session.

For example, the network slice identity regarding the released PDU session may be S-NSSAI-3.

“the PDU-Id with value which is set to OFF” may be expressed as “PDU-Id=OFF”.

The Nnsacf_SliceUsageNotify message in step 8 may be expressed as a message related to release of PDU session(s) for S-NSSAI-3.
9. If the NSACF 7701 has an active usage control timer for the UE 3 for S-NSSAI-3, the NSACF 7701 restarts the ‘usage control timer’ for S-NSSAI-3. For example, in a case where the Nnsacf_SliceUsageNotify message includes PDU-Id with value which is set to OFF and S-NSSAI-3, the NSACF 7701 may determine that the active PDU session identified by the PDU-Id on a network slice identified by S-NSSAI-3 is released. In this case, if the NSACF 7701 stops the usage control timer for S-NSSAI-3 in step 6, the NSACF 7701 may restart the usage control timer for S-NSSAI-3. When restarting the usage control timer, the NSACF 7701 may restart the usage control timer from beginning or from the middle. For example, in a case where the usage control timer is set to 100 seconds and the usage control timer has already measured 10 seconds when the NSACF 7701 stops the usage control timer in step 6, the NSACF 7701 may restart the usage control timer with value which is set to 100 seconds or may restart the usage control timer with value which is set to 90 seconds.
10. After some time the ‘usage control timer’ for S-NSSAI-3 for the UE 3 expires as no activity is notified for S-NSSAI-3 by the UE 3 for some time. For example, as the UE 3 has not used S-NSSAI-3, i.e. the UE 3 has not requested service or has not established a PDU session on S-NSSAI-3 for some time, the ‘usage control timer’ for the UE 3 for S-NSSAI-3 expires. For example, the NSACF 7701 may detect the usage control timer for S-NSSAI-3 for the UE 3 expires.
11. At ‘usage control timer’ expiry for a network slice, e.g. S-NSSAI-3, the NSACF 7701 sends, to the AMF 70, an Nnsacf_SliceUsageNotification message including UE_Id, S-NSSAI-3, and a status parameter which is set to inactive. The Nnsacf_SliceUsageNotification message may include a cause parameter which is set to usage control timer expired. The NSACF 7701 may include the following parameters:
   UE-Id—identity of the UE 3.
   S-NSSAI-3—network slice identity for which the ‘usage control timer’ expires.
   Status parameter—the NSACF 7701 may include the status parameter to indicate whether the notified network slice, e.g. S-NSSAI-3 has been inactive for some time, e.g. until expiry of the usage control timer for that network slice. For example, the status parameter which is set to inactive may mean that a network slice identified by the network slice identity in the Nnsacf_SliceUsageNotification message has been inactive until expiry of the usage control timer for that network slice. For example, in a case where the Nnsacf_SliceUsageNotification message includes S-NSSAI-3 as the network slice identity, the status parameter which is set to inactive may mean that a network slice identified by S-NSSAI 3 has been inactive or has not been used by the UE 3 until expiry of the usage control timer for that network slice. The status parameter which is set to inactive may be expressed as “status=inactive”.
   Cause parameter—Optionally the NSACF 7701 may also include the cause parameter to indicate reason for which the network slice is indicated as inactive, e.g. usage control timer expired. For example, the cause parameter which is set to ‘usage control timer expired’ may mean that the network slice is inactive as the usage control timer for the network slice expired. The cause parameter which is set to ‘usage control timer expired’ may be expressed as “cause=usage control timer expired”.

For example, after the step 10, the NSACF 7701 may send, to the AMF 70, a message indicating a network slice (e.g. a network slice identified by S-NSSAI-3) is not used.
12. When the AMF 70 is notified from the NSACF 7701 for a network slice, e.g. S-NSSAI-3 being inactive with a cause set to usage control timer expired or any other notation for a cause or status to indicate that the notified network slice has not been used or been inactive for some time (e.g. in a case where the AMF 70 receives the Nnsacf_SliceUsageNotification message including the UE-Id, S-NSSAI-3 and the status parameter which is to inactive or in a case where the AMF 70 receives the Nnsacf_SliceUsageNotification message including the UE-Id, S-NSSAI-3, the status parameter which is to inactive and the cause parameter which is set to ‘usage control timer expired’), the AMF 70 may follow one of the following behaviours below:

The AMF 70 may deregister the UE 3 from the network slice which the UE 3 has not used for some time, e.g. S-NSSAI-3 by removing S-NSSAI-3 from the Allowed NSSAI for the UE 3 and adding S-NSSAI-3 to the Rejected NSSAI as described in steps 11 and 12 of the Second Example of the First Aspect.

The AMF 70 may keep the UE 3 registered with the network slice that was reported as inactive or not used e.g. S-NSSAI-3 and mark the network slice identified by S-NSSAI-3 as inactive or not used in the UE 3's context within the AMF 70. The AMF 70 may deregister that network slice, e.g. S-NSSAI-3 from the NSACF 7701 as per clause 4.2.11 of NPL 3 so that S-NSAAI-3 is not counted for the quota control purposes as S-NSSAI-3 is not active or not being used for certain time. As soon as the inactive network slice, e.g. S-NSSAI-3 is used again by the UE 3, e.g. a PDU session is established on S-NSSAI-3, the AMF 70 registers back that network slice with the NSACF 7701 for the purposes of the quota control. For example, in a case where the AMF 70 may determine that the inactive network slice, e.g. S-NSSAI-3 is used again by the UE 3, the AMF 70 may instruct the NSACF 7701 to count the UE 3 for the quota control. For example, the AMF 70 may determine that the inactive network slice, e.g. S-NSSAI-3 is used again by the UE 3 in a case where the AMF 70 receives, from other network node (e.g. the SMF 71 or the UE 3) information indicating that the inactive network slice, e.g. S-NSSAI-3 is used again by the UE 3.

The Nnsacf_SliceUsageNotification message may be expressed as a message for removing S-NSSAI-3 from the Allowed NSSAI. The Nnsacf_SliceUsageNotification message may be expressed as a message for adding S-NSSAI-3 to the Rejected NSSAI. The Nnsacf_SliceUsageNotification message may be expressed as a message for deregister S-NSSAI-3.

For example, a communication apparatus corresponding to the NSACF 7701 may receive a first message. The first message may include Single Network Slice Selection Assistance Information (S-NSSAI). The communication apparatus may start a timer for the S-NSSAI after receiving the first message. The timer may be set to a value associated with the S-NSSAI. The communication apparatus may receive a second message related to establishment of a Protocol Data Unit (PDU) session for the S-NSSAI after starting the timer. The communication apparatus may stop the timer after receiving the second message. The communication apparatus may receive a third message related to release of the PDU session after stopping the timer. The communication apparatus may start the timer after receiving the third message. The communication apparatus may send a fourth message in a case where the timer expires. The fourth message may be for removing the S-NSSAI from an Allowed Network Slice Selection Assistance Information (NSSAI) or may be for deregister the S-NSSAI.

For example, a first network slice control function node corresponding to the NSACF 7701 may receive, from a core network apparatus corresponding to the AMF 70, a message related to management of a network slice. The first network slice control function node may start a timer for the network slice after receiving the message. The first network slice control function node may detect the timer is expired. The first network slice control function node may send, to the core network apparatus, a message indicating at least one of the time is expired or the network slice related to the timer is not used, after the detecting the timer is expired.

For example, a first network slice control function node corresponding to the NSACF 7701 may receive, from a core network apparatus corresponding to the AMF 70, a message related to management of a network slice. The first network slice control function node may start a timer for the network slice after receiving the message. The first network slice control function node may receive, from a second network slice control function node corresponding to the NSACF 7702, a message detecting an activity related to the network slice. The first network slice control function node may stop the timer after receiving the message.

According to the above, the above problem such as whether and how to enhance the system to ensure network-controlled behavior of network slice usage including UE registration and PDU Session establishment can be solved.

### Variant 1 of the Third Example of the First Aspect

In step 2, the Nnsacf_NSAC_NumOfUEsUpdate_Request message may not include the usage control parameter.

For example, the NSACF 7701 may understand that network slice(s) identified by S-NSSAT(s) in the Nnsacf_NSAC_NumOfUEsUpdate_Request message is subject to usage control or subject to inactivity control based on inclusion of the S-NSSAI(s) and the usage control timer parameter.

In a case where the NSACF 7701 receives the Nnsacf_NSAC_NumOfUEsUpdate_Request message without the usage control parameter in step 2, the NSACF 7701 may start the usage control timers for S-NSSAI-1, S-NSSAI-2 and S-NSSAI-3 in step 3 and the subsequent processes may be performed in accordance with the Third Example of the First Aspect.

In step 2, the Nnsacf_NSAC_NumOfUEsUpdate_Request message may not include the usage control parameter and the usage control timer parameter.

For example, the NSACF 7701 may understand that network slice(s) identified by S-NSSAI(s) in the Nnsacf_NSAC_NumOfUEsUpdate_Request message is subject to usage control or subject to inactivity control based on reception of the Nnsacf_NSAC_NumOfUEsUpdate_Request message.

In a case where the NSACF 7701 receives the Nnsacf_NSAC_NumOfUEsUpdate_Request message without the usage control parameter and the usage control timer parameter in step 2, the NSACF 7701 may start the usage control timers for S-NSSAI-1, S-NSSAI-2 and S-NSSAI-3 in step 3 and the subsequent processes may be performed in accordance with the Third Example of the First Aspect. In this case, the NSACF 7701 may configure value of the usage control timer(s) based on local configuration of the NSACF 7701 or operator's policy stored in the NSACF 7701.

### Fourth Example of the First Aspect

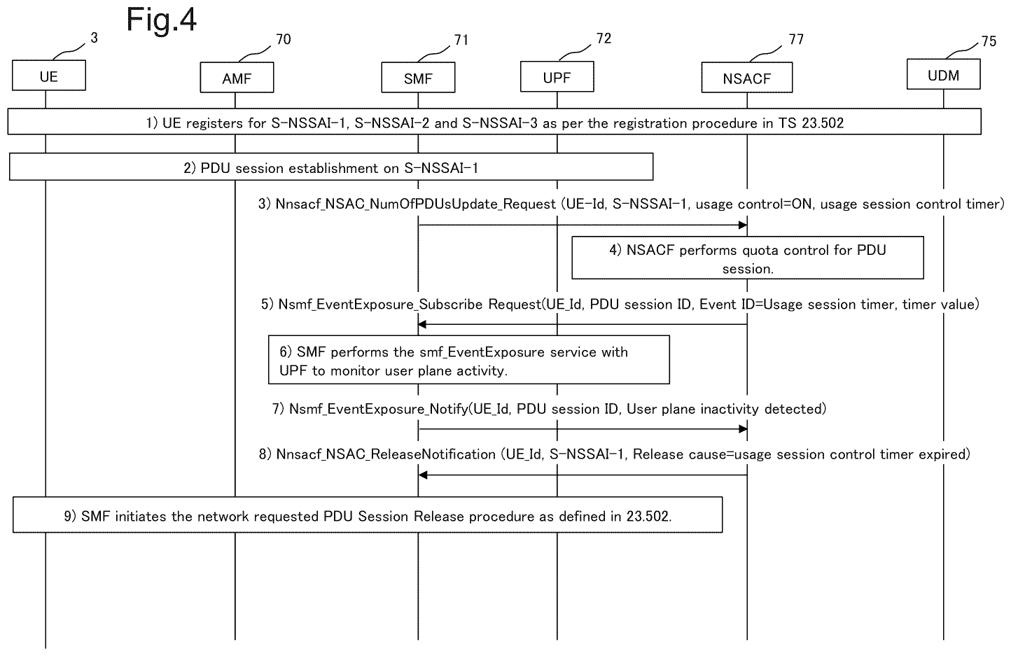

The Fourth Example of the First Aspect in FIG. 4 discloses a mechanism which enables a network to release PDU session(s) that is associated with a network slice via an NSACF 77 if there is no user plane activity for a long time.
1. A UE 3 registers with an AMF 70 for network slice(s), e.g. network slices which are identified by S-NSSAI-1, S-NSSAI-2 and S-NSSAI-3 and which are supported by a network and by the AMF 70 in the UE 3's location. For example, the UE 3 may perform a registration procedure for S-NSSAI-1, S-NSSAI-2 and S-NSSAI-3 as per NPL 3.
2. At some stage of the UE 3 which has an Allowed NSSAI including S-NSSAI-1, S-NSSAI-2 and S-NSSAI-3, the UE 3 requests a service or PDU session establishment on S-NSSAI-1, for example.
3. An SMF 71 registers PDU session(s) established on S-NSSAI-1 with an NSACF 77 for the maximum number of PDU sessions quota control by sending an Nnsacf_NSAC_NumOfPDUsUpdate_Request message including UE-Id, S-NSSAI-1, usage control which is set to ON, and usage session control timer. The Nnsacf_NSAC_NumOfPDUsUpdate_Request message may include a PDU session ID which identifies PDU session(s) established in step 2.

The UE-Id may be identity of the UE 3.

The usage control which is set ON may indicate to the NSACF 77 that the network slice(s) is subject to usage control or subject to inactivity control. In this case, the usage control which is set ON may indicate to the NSACF 77 that S-NSSAI-1 (or a network slice identified by S-NSSAI-1) is subject to usage control or subject to inactivity control. “usage control which is set ON” may be expressed as “usage control=ON”. The usage control may be expressed as a usage control parameter.

The usage session control timer may define a time or time period for which if the network slice(s) is not used by the UE 3, e.g. if no service request or no PDU session is established by the UE 3 on the network slice(s), the UE 3 is to be deregistered from the network slice. In this case, the usage session control timer may define a time or time period for which if a network slice identified by S-NSSAI-1 is not used by the UE 3, e.g. if no service request or no PDU session is established by the UE 3 on the network slice, the UE 3 is to be deregistered from the network slice.

For example, the SMF 71 may configure the usage session control timer based on a local configuration in the SMF 71 or network operator policy within the SMF 71.

The usage session control timer may be expressed as a usage session control timer parameter. For example, the SMF 71 may send to the NSACF 77, a message related to management of a network slice to initiate control of a number of sessions (e.g. PDU sessions) by the NSACF 77 based on the usage session control timer.
4. Upon reception of the Nnsacf_NSAC_NumOfPDUsUpdate_Request message, the NSACF 77 performs quota control for PDU session as per clause 4.2.11 of NPL 3.
5. If the Nnsacf_NSAC_NumOfPDUsUpdate_Request message includes the usage control which is set to ON, then the NSACF 77 sends an Nsmf_EventExposure_Subscribe Request message to the SMF 71 including UE_Id, PDU session ID, Event ID which is set to Usage session timer, and timer value.

The UE-Id may be identity of the UE 3.

The PDU session ID may be identity of a PDU session. The PDU session ID may be identity of a PDU session established on a network slice identified by S-NSSAI-1.

The PDU session ID may be same to one received in the step 3.

The Event ID may identify type of event being subscribed to.

The Event ID which is set to Usage session timer may indicate that network slice(s) is subject to usage control or subject to inactivity control. In this case, the Event ID which is set to Usage session timer may indicate that S-NSSAI-1 (or a network slice identified by S-NSSAI-1) is subject to usage control or subject to inactivity control.

For example, the Event ID which is set to Usage session timer may indicate that the UE 3 is to be deregistered from network slice(s) if the network slice(s) is not used by the UE 3, e.g. if no service request or no PDU session is established by the UE 3 on the network slice(s). In this case, the Event ID which is set to Usage session timer may indicate that the UE 3 is to be deregistered from a network slice identified by S-NSSAI-1 if the network slice is not used by the UE 3, e.g. if no service request or no PDU session is established by the UE 3 on the network slice.

“Event ID which is set to Usage session timer” may be expressed as “Event ID=Usage session timer”.

The timer value may be configured by the NSACF 77 based on local configuration in the NSACF 77 or may be same to value of the usage session control timer that is received in the Nnsacf_NSAC_NumOfPDUsUpdate_Request message in step 3. The timer value may be associated with the PDU session ID. For example, the NSACF 77 sends, to the SMF 71, a message indicating the control of a number of sessions (e.g. PDU sessions) by the NSACF 77 based on the usage session control timer is initiating or initiated.
6. Upon reception of the Nsmf_EventExposure_Subscribe Request message from the NSACF 77, the SMF 71 performs an Nsmf_EventExposure service with the UPF 72 to monitor user plane activity for the PDU session as described in clause 5.2.8.3 of NPL 3. For example, the SMF 71 may determine whether to detect user plane activity within time period specified by the timer value received in step 5, regarding the PDU session identified by the PDU session ID received in step 5. For example, the SMF 71 may determine whether to detect user plane activity per UE identified by the UE-Id within time period specified by the timer value, regarding the PDU session identified by the PDU session ID. In a case where the SMF 71 determine whether to detect user plane activity within time period specified by the timer value, the SMF 71 may use a timer which is set to the time period specified by the timer value. For example, the SMF 71 may monitor user plane activity after receiving the message indicating the control of a number of sessions (e.g. PDU sessions) by the NSACF 77 based on the usage session control timer is initiating or initiated in step 5.
7. If the SMF 71 detects that there is no user plane activity within time period specified by the timer value in step 5, the SMF 71 sends an Nsmf_EventExposure_Notify message to the NSACF 77 indicating that the user inactivity in the specified PDU session has been detected.

For example, in a case where the SMF 71 detects that there is no user plane activity within time period specified by the timer value regarding the PDU session identified by the PDU session ID, the SMF 71 may send the Nsmf_EventExposure_Notify message to the NSACF 77 indicating that the user inactivity in the PDU session has been detected.

The Nsmf_EventExposure_Notify message may include UE-Id and PDU session ID.

The UE-Id may be identity of the UE 3. The UE-Id may be same to one received in step 5.

The PDU session ID may be identity of a PDU session. The PDU session ID may be identity of a PDU session established on a network slice identified by S-NSSAI-1. The PDU session ID may be same to one received in step 5.

For example, the SMF 71 may send the Nsmf_EventExposure_Notify message in a case where there is no user plane activity for the PDU session until the timer of the SMF 71 expires.

The Nsmf_EventExposure_Notify message may indicate that there is no user plane activity for the PDU session.

The Nsmf_EventExposure_Notify message may include information indicating that there is no user plane activity for the PDU session. The information may be expressed as information indicating “User plane inactivity detected”. For example, the SMF 71 sends, to the NSACF 77, a message indicating the user plane activity is not detected based on the monitoring or the result of the monitoring in step 6.
8. Upon reception of the Nsmf_EventExposure_Notify message in step 7, the NSACF 77 sends, to the SMF 71, an Nnsacf_NSAC_ReleaseNotification message including UE_Id, S-NSSAI-1, Release cause which is set to usage session control timer expired.

The UE-Id may be identity of the UE 3. The UE-Id may be same to one received in step 7.

The Nsmf_EventExposure_Notify message may include network slice identity that identifies network slice(s) on which there is no user plane activity within time period specified by the timer value. In this case, the Nsmf_EventExposure_Notify message may include S-NSSAI-1.

The Release cause may indicate reason why PDU session(s) established on network slice(s) is released.

For example, in a case where the NSACF 77 receives the Nsmf_EventExposure_Notify message indicating that the user inactivity in the specified PDU session has been detected, the NSACF 77 may set the Release cause to usage session control timer expired. The Release cause which is set to usage session control timer expired may mean that PDU session(s) established on network slice(s) is released as there is no user plane activity within time period specified by the timer value.

For example, in a case where the NSACF 77 receives the Nsmf_EventExposure_Notify message indicating that the user inactivity in the PDU session on a network slice identified by S-NSSAI-1 has been detected, the NSACF 77 may set the Release cause for the S-NSSAI-1 to usage session control timer expired.

The Release cause may be associated with the PDU session ID received in step 7.

“Release cause which is set to usage session control timer expired” may be expressed as “Release cause=usage session control timer expired”. For example, the SMF 71 may receive, from the NSACF 77, a message indicating at least one of the usage session control timer expired and the PDU session is not active state.
9. Upon reception of the Nnsacf_NSAC_ReleaseNotification message in step 8, the SMF 71 initiates a network requested PDU Session Release procedure as described in clause 4.3.4.2 of NPL 3. As the result, the PDU session quota control for S-NSSAI 1 is performed between the SMF 71 and the NSACF 77, i.e. the number of PDU sessions for S-NSSAI 1 is decremented in the NSACF 77 due to the network requested PDU Session Release procedure took place in step 9.

For example, in step 9, the SMF 71 may initiate the network requested PDU Session Release procedure for S-NSSAI-1.

For example, in step 9, the SMF 71 may initiate the network requested PDU Session Release procedure for a PDU session identified by the PDU session ID sent in step 7.

For example, in a case where the Nnsacf_NSAC_ReleaseNotification message includes the Release cause with a PDU session ID, the SMF 71 may initiate the network requested PDU Session Release procedure for a PDU session identified by the PDU session ID.

Upon reception of the Nsmf_EventExposure_Notify message in step 7, the NSACF 77 may decrease the number of PDU session established on network slice(s) for quota control of PDU session(s). In this case, the NSACF 77 may decrease, by 1, the number of PDU session established on a network slice identified by S-NSSAI-1.

The Nnsacf_NSAC_ReleaseNotification message may be expressed as a message for performing the network requested PDU Session Release procedure.

The Nnsacf_NSAC_ReleaseNotification message may be expressed as a message for performing a procedure to release the PDU session.

For example, a communication apparatus corresponding to the SMF 71 may send a first message. The first message may include Single Network Slice Selection Assistance Information (S-NSSAI). The communication apparatus may receive a second message. The second message may include identity of a Protocol Data Unit (PDU) session. The communication apparatus may start a timer after receiving the second message. The communication apparatus may send a third message in a case where there is no user plane activity for the PDU session until the timer expires. The third message may indicate that there is no user plane activity for the PDU session. The communication apparatus may receive a fourth message after sending the third message. The communication apparatus may perform a procedure to release the PDU session after receiving the fourth message.

For example, a communication apparatus corresponding to the NSACF 77 may receive a first message. The first message may include Single Network Slice Selection Assistance Information (S-NSSAI). The communication apparatus may send a second message. The second message may include identity of a Protocol Data Unit (PDU) session. The communication apparatus may receive a third message after sending the second message. The third message may indicate that there is no user plane activity for the PDU session. The communication apparatus may send a fourth message after receiving the third message. The fourth message may be for performing a procedure to release the PDU session.

For example, a first core network apparatus corresponding to the SMF 71 may send, to a second core network apparatus corresponding to the NSACF 77, first information related to management of a network slice to initiate a control of a number of sessions based on a timer. The first core network apparatus may receive, from the second core network apparatus, second information indicating the control is initiated. The first core network apparatus may monitor user plane activity related to the sessions after receiving the second information. The first core network apparatus may send, to the second core network apparatus, third information indicating the user plane activity is not detected based on the monitoring. The first core network apparatus may receive, from the second core network apparatus, forth information indicating at least one of the timer is expired or the session is not active within the period specified by the timer.

For example, a first core network apparatus corresponding to the NSACF may receive, from a second core network apparatus corresponding to the SMF 71, first information related to management of a network slice. The first core network apparatus may start a timer for the network slice after receiving the first information. The first core network apparatus may send, to the second core network apparatus, second information indicating the management is initiated to start monitoring user plane activity related to a session. The first core network apparatus may receive, from the second core network apparatus, third information indicating the user plane activity is not detected based on the monitoring. The first core network apparatus may send to the second core network apparatus, fourth information indicating at least one of the timer is expired or the session is not active within the period specified by the timer.

According to the above, the above problem such as whether and how to enhance the system to ensure network-controlled behavior of network slice usage including UE registration and PDU Session establishment can be solved.

### Variant 1 of the Fourth Example of the First Aspect

In a case where the SMF 71 solely performs the usage session control timer handling, step 5, step 7 and step 8 does not take place. The timer value that is used in step 6 may be set based on local configuration in the SMF 71 or based on operator's policy in the SMF 71.

When the SMF 71 detects that there is no user plane activity in specified time period by the timer value, step 9 takes place to release the PDU session that is associated with S-NSSAI 1.

For example, in a case where the SMF 71 detects that there is no user plane activity within specified time period by the timer value, the SMF 71 performs the procedure to release the PDU session that is associated with the PDU session ID sent in step 3.

### Variant 2 of the Fourth Example of the First Aspect

In step 3, the Nnsacf_NSAC_NumOfPDUsUpdate_Request message may not include the usage control parameter.

For example, the NSACF 77 may understand that network slice(s) identified by S-NSSAI(s) in the Nnsacf_NSAC_NumOfPDUsUpdate_Request message is subject to usage control or subject to inactivity control based on inclusion of the S-NSSAI(s) and the usage session control timer parameter.

In a case where the NSACF 77 receives the Nnsacf_NSAC_NumOfPDUsUpdate_Request message without the usage control parameter in step 3, the NSACF 77 may perform the process in step 4 and send, to the SMF 71, the Nsmf_EventExposure_Subscribe Request message with or without the Event ID in step 5.

Then the SMF 71 may perform the process in step 6 and the subsequent processes may be performed in accordance with the Fourth Example of the First Aspect.

In step 3, the Nnsacf_NSAC_NumOfPDUsUpdate_Request message may not include the usage control parameter and the usage session control timer parameter.

For example, the NSACF 77 may understand that network slice(s) identified by S-NSSAI(s) in the Nnsacf_NSAC_NumOfPDUsUpdate_Request message is subject to usage control or subject to inactivity control based on reception of the Nnsacf_NSAC_NumOfPDUsUpdate_Request message.

In a case where the NSACF 77 receives the Nnsacf_NSAC_NumOfPDUsUpdate_Request message without the usage control parameter and the usage session control timer parameter in step 3, the NSACF 77 may perform the process in step 4 and send, to the SMF 71, the Nsmf_EventExposure_Subscribe Request message with or without the Event ID in step 5.

In a case where the Nnsacf_NSAC_NumOfPDUsUpdate_Request message does not include the usage session control timer parameter, the NSACF 77 may configure the timer value based on local configuration of the NSACF 77 or operator's policy stored in the NSACF 77, and send the timer value by the Nsmf_EventExposure_Subscribe Request message.

Then the SMF 71 may perform the process in step 6 and the subsequent processes may be performed in accordance with the Fourth Example of the First Aspect.

In another example, in a case where the Nnsacf_NSAC_NumOfPDUsUpdate_Request message does not include the usage session control timer parameter, the NSACF 77 may not include the timer value in the Nsmf_EventExposure_Subscribe Request message. In this case, the SMF 71 may configure the timer value based on local configuration of the SMF 71 or operator's policy stored in the SMF 71. Then the SMF 71 may perform the process in step 6 and the subsequent processes may be performed in accordance with the Fourth Example of the First Aspect.

### <System Overview>

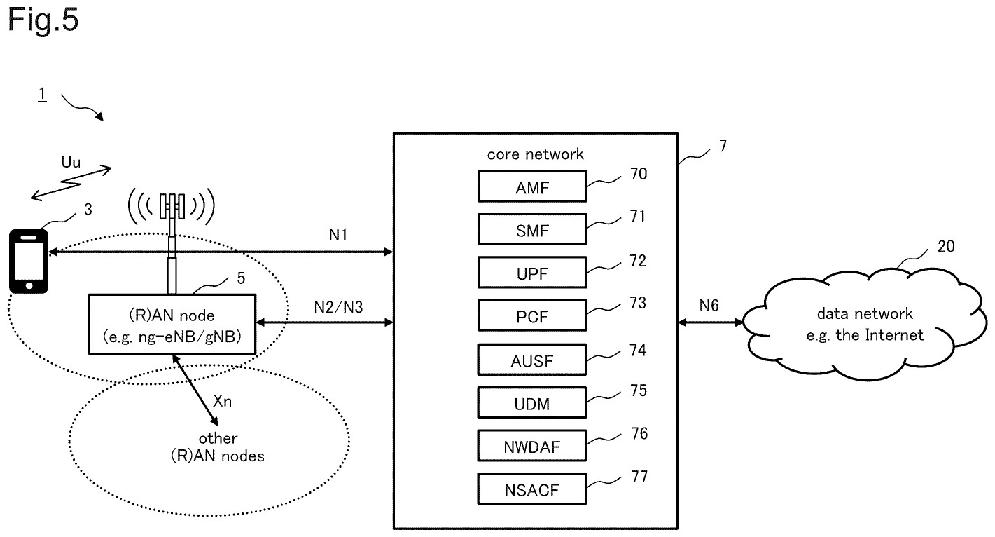

FIG. 5 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, a Network Data Analytics Function (NWDAF) 76 and a Network Slice Admission Control Function (NSACF) 77. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
   establishmentCause and ue-Identity. The ue-Identity may have a value of ng-5G-S-TMSI-Part1 or randomValue.
RRC Setup message: This message is sent from the (R)AN node 5 to the UE 3. In addition to the parameters that are disclosed by Aspects in this disclosure, following parameters may be included together in the RRC Setup message.
   masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
   guami-Type, iab-Nodelndication, idleMeasAvailable, mobilityState, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
   SOR transparent container.
Authentication Request message: This message is sent from the AMF 70 to the UE 3. In addition to the parameters that are disclosed by Aspects in this disclosure, following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
   EAP message.
Service Request message: This message is sent from the UE 3 to the AMF 70. In addition to the parameters that are disclosed by Aspects in this disclosure, following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
   Configuration update complete message identity.

### <User Equipment (UE)>

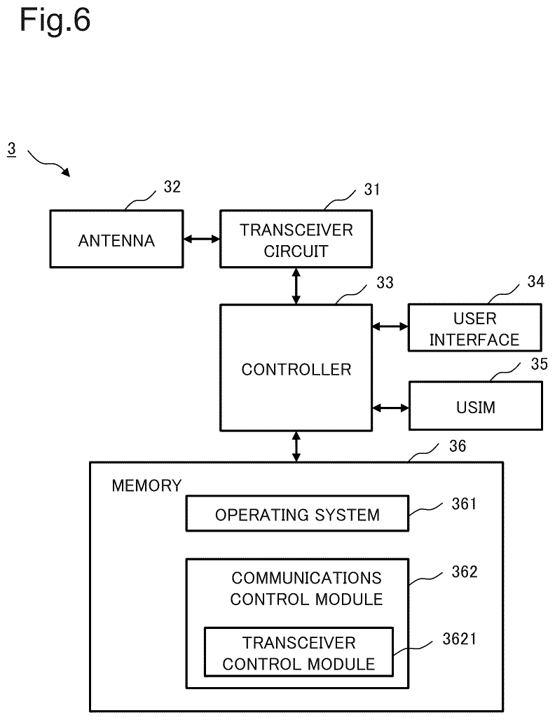

FIG. 6 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment; electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

<(R)AN node>

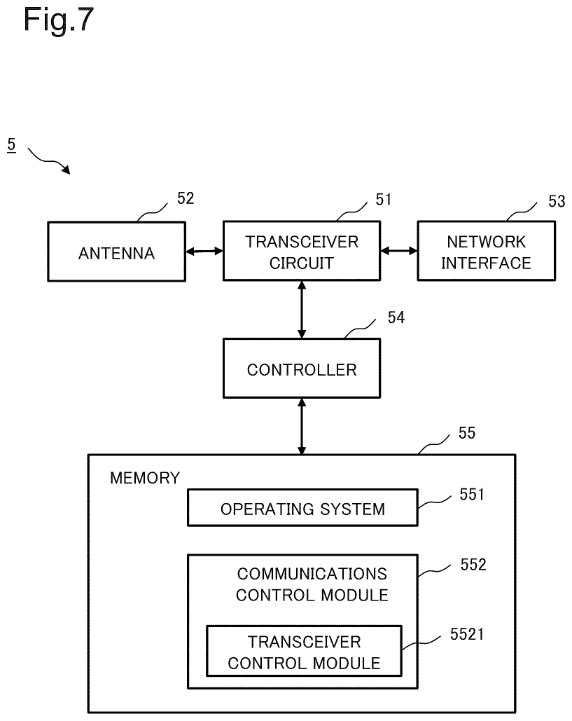

FIG. 7 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

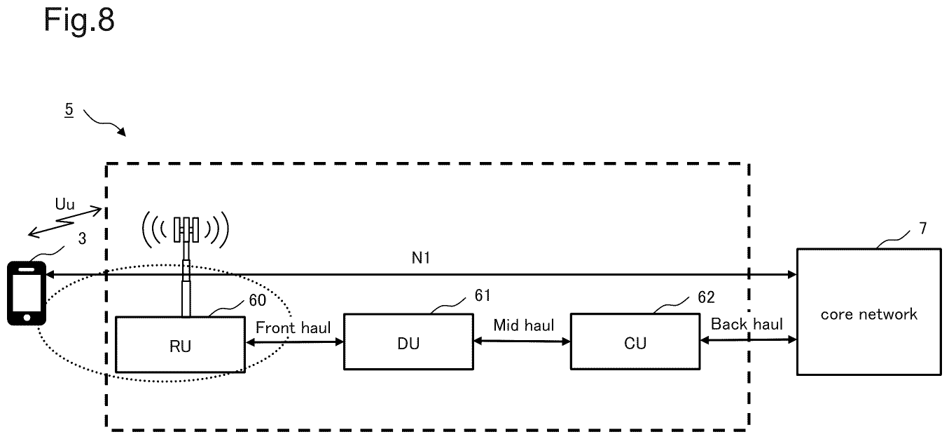

FIG. 8 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

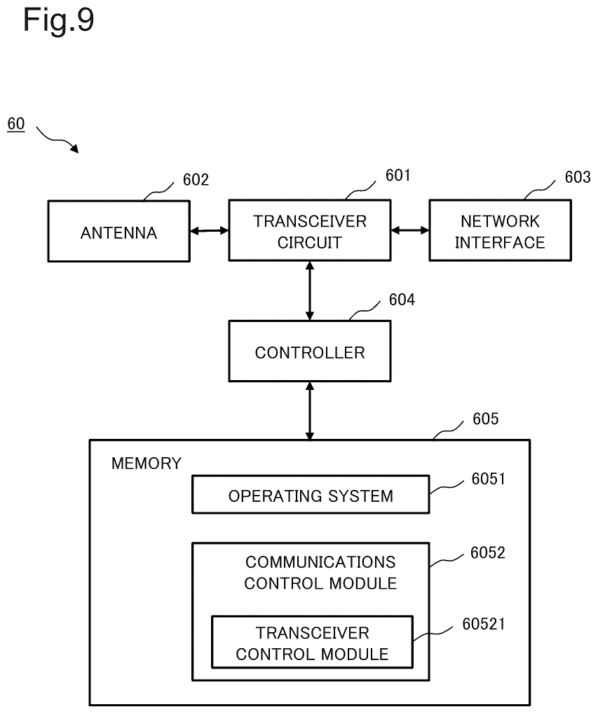

FIG. 9 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

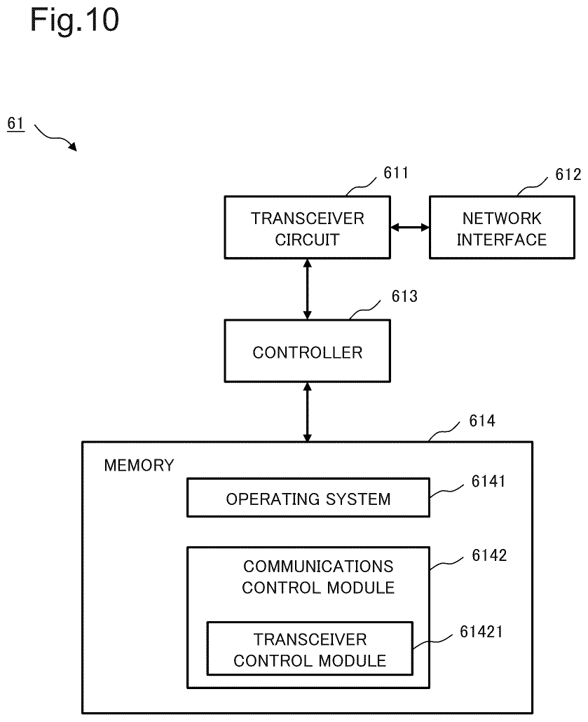

FIG. 10 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

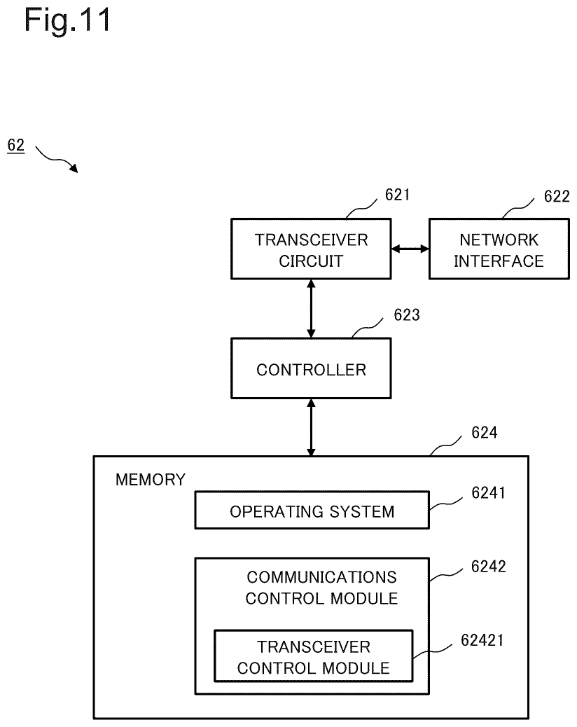

FIG. 11 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

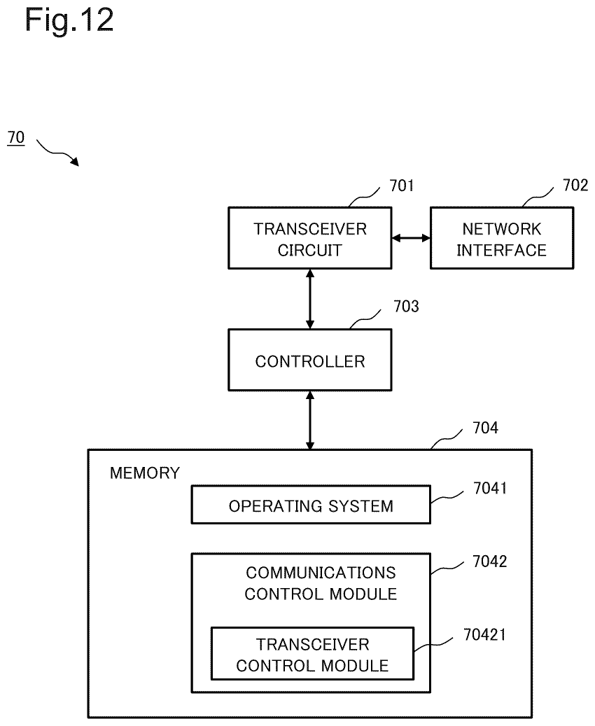

FIG. 12 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <UPF>

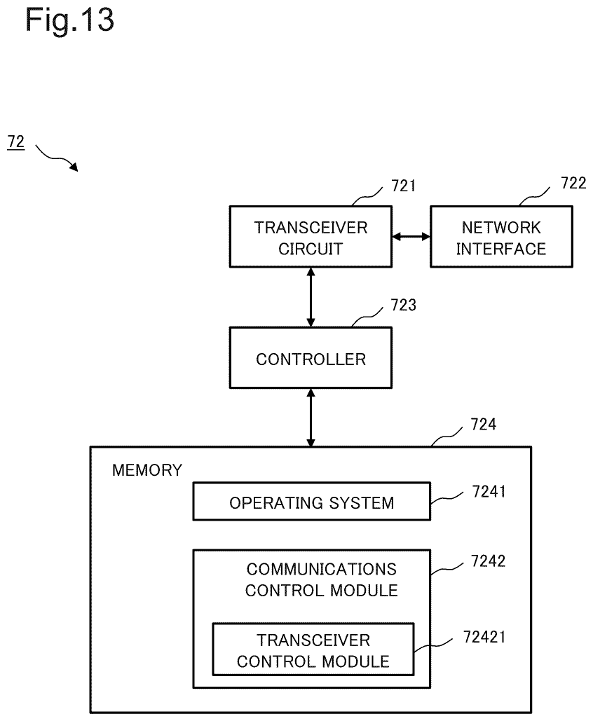

FIG. 13 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communication s control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### <PCF>

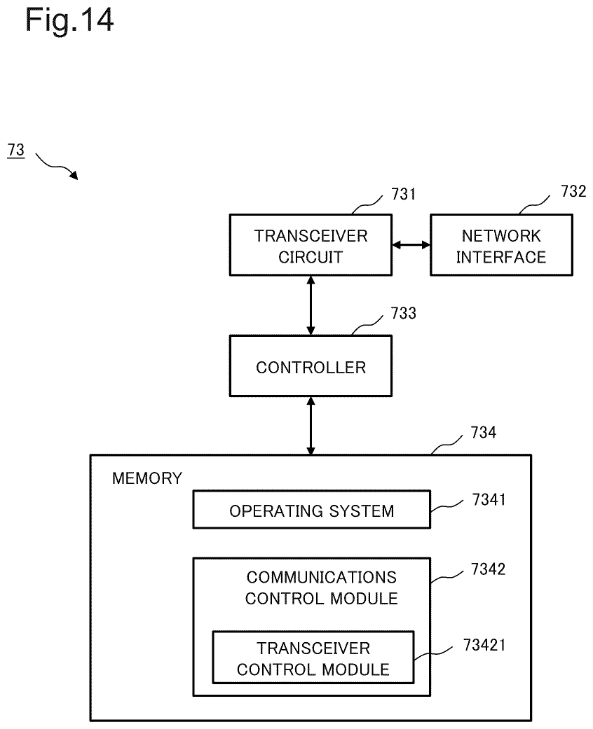

FIG. 14 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communication s control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <AUSF>

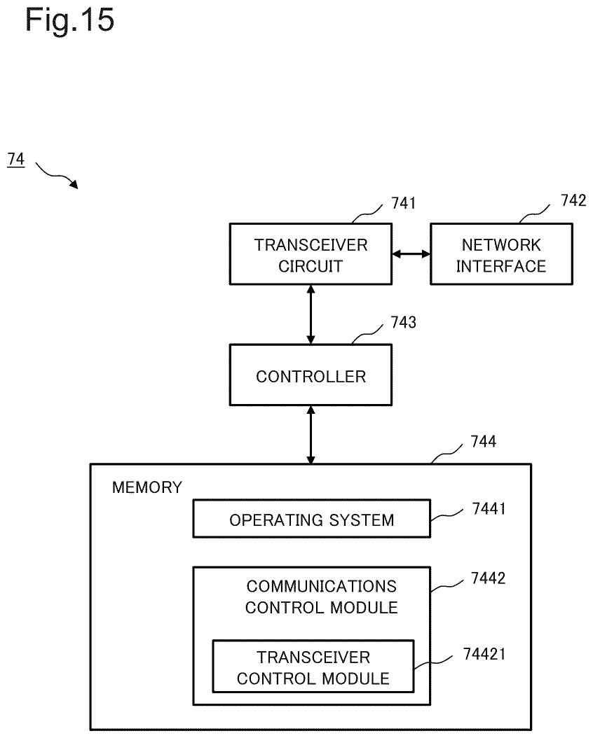

FIG. 15 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communication s control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### <UDM>

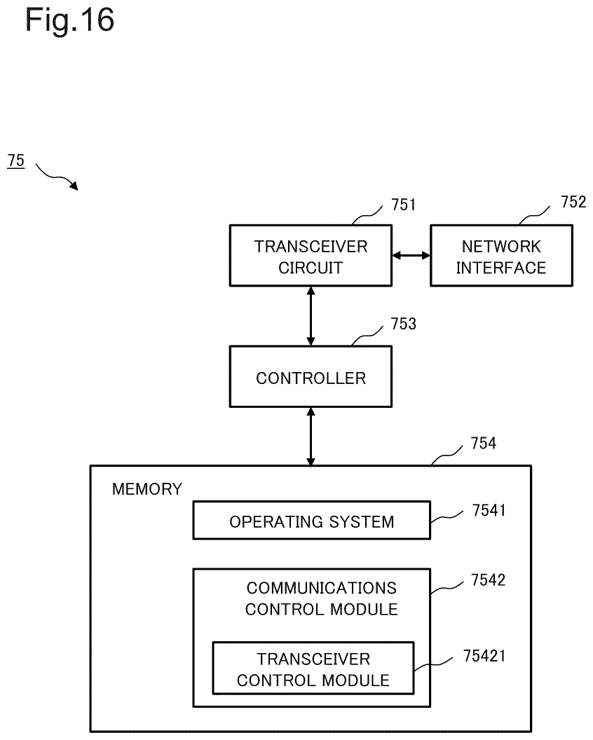

FIG. 16 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NWDAF>

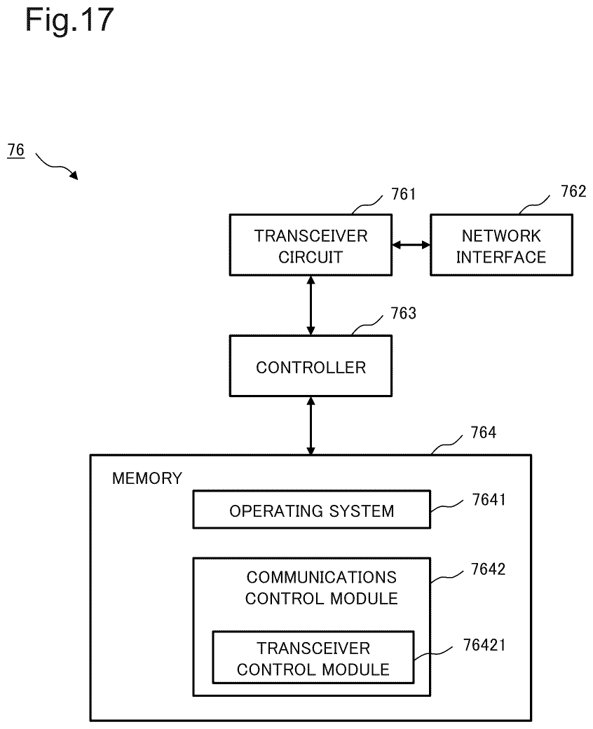

FIG. 17 is a block diagram illustrating the main components of the NWDAF 76. As shown, the apparatus includes a transceiver circuit 751 which is operable to transmit signals to and to receive signals from other nodes (including the AMF 70, the SMF 71, and the NSACF 77) via a network interface 762. A controller 763 controls the operation of the NWDAF 76 in accordance with software stored in a memory 764. Software may be pre-installed in the memory 764 and/or may be downloaded via the telecommunication network or from a removable data storage device (RMD), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NWDAF 76 may support the Non-Public Network (NPN), The NPN may be a Stand-alone Non-Public Network (SNPN) or a Public Network Integrated NPN (PNI-NPN).

### <NSACF>

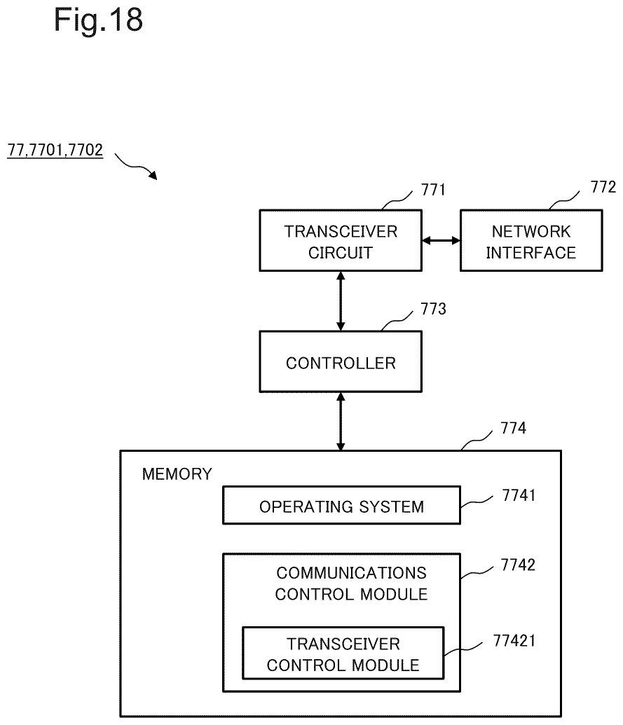

FIG. 18 is a block diagram illustrating the main components of the NSACF 77. As shown, the apparatus includes a transceiver circuit 771 which is operable to transmit signals to and to receive signals from other nodes (including the AMF 70) via a network interface 772. A controller 773 controls the operation of the NSACF 77 in accordance with software stored in a memory 774. Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NSACF 77 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The NSACF 77 may support the Non-Public Network (NPN), The NPN may be a Stand-alone Non-Public Network (SNPN) or a Public Network Integrated NPN (PNI-NPN). The NSACF 7701 and the NSACF 7702 may have same components to the NSACF 77.

The whole or part of the example Aspects disclosed above can be described as, but not limited to, the following.

### <4.2.11.2 Number of UEs Per Network Slice Availability Check and Update Procedure>

The number of UEs per network slice availability check and update procedure is to update (i.e. increase or decrease) the number of UEs registered with a S-NSSAI which is subject to NSAC. The AMF is configured with the information indicating which network slice is subject to NSAC.

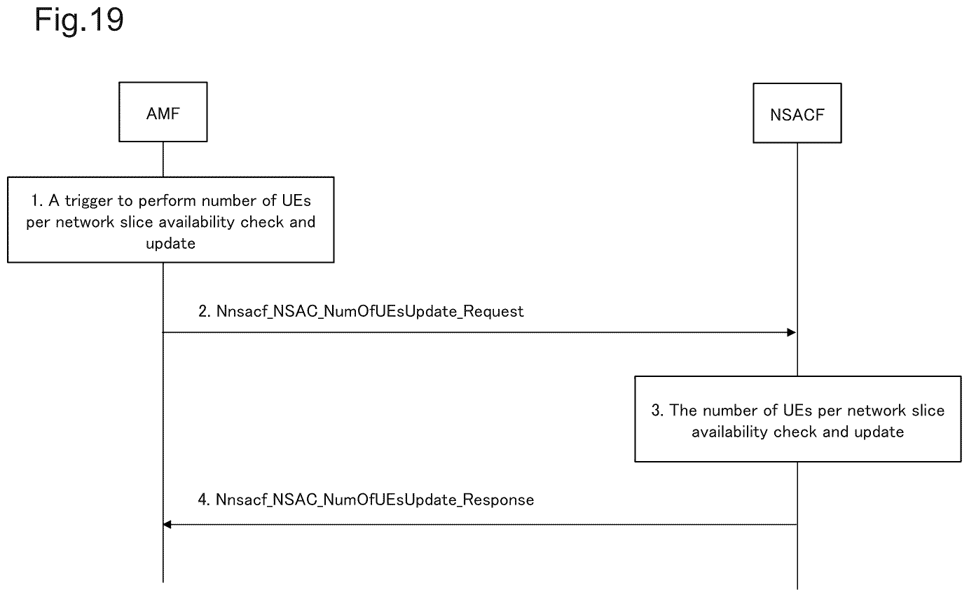

FIG. 4.2.11.2-1: Number of UEs per network slice availability check and update procedure (See FIG. 19.)
1. If the AMF is not aware of which NSACF to communicate, the AMF performs NSACF discovery as described in clause 6.3.22 of TS 23.501 [2] and in clause 5.2.7.3.2. The AMF triggers the Number of UEs per network slice availability check and update procedure to update the number of UEs registered with a network slice when a network slice subject to NSAC is included in the Allowed NSSAI (i.e. the AMF requests to register the UE with the S-NSSAI) or removed from the Allowed NSSAI (i.e. the AMF requests to de-register the UE from the S-NSSAI) for a UE. The trigger event at the AMF also includes the change of Allowed NSSAI in case of inter-AMF mobility. The procedure is triggered in the following cases:
   At UE Registration procedure, according to clause 4.2.2.2.2 (including Registration types of Initial Registration or Mobility Registration Update in inter-AMF mobility in CM-CONNECTED or CM-IDLE state):
      before the Registration Accept in step 21 if the EAC mode is active; or
      after the Registration Accept message if the EAC mode is not active;
   At UE Deregistration procedure, as per clause 4.2.2.3, after the Deregistration procedure is completed;
   At UE Configuration Update procedure (which may result from NSSAA procedure or subscribed S-NSSAI change):
      before the UE Configuration Update message if the EAC mode is active and the update flag is to increase; or
      after the UE Configuration Update message if the EAC mode is active and the update flag is to decrease; or
      after the UE Configuration Update message if the EAC mode is not active.

NOTE 1: Depending on the deployment, there may be different NSACF for different S-NSSAI subject to NSAC, and hence, during the registration, AMF triggers the Number of UEs per network slice availability check and update procedure to multiple NSACFs.
2. The AMF sends Nnsacf_NSAC_NumOfUEsUpdate_Request message to the NSACF. The AMF includes in the message the UE ID, access type, the S-NSSAI(s), the NF ID and the update flag which indicates whether the number of UEs registered with the S-NSSAI(s) is to be increased when the UE has gained registration to network slice(s) subject to NSAC or the number of UEs registered with the S-NSSAI(s) is to be decreased when the UE has deregistered from S-NSSAI(s) or could not renew its registration to an S-NSSAI subject to NSAC.

If this is the first time to perform NSAC procedure for the S-NSSAI towards the NSACF, the AMF includes notification endpoint for EAC Notification to implicitly subscribe the EAC notification for the S-NSSAI from the NSACF.
3. The NSACF updates the current number of UEs registered for the S-NSSAI, i.e. increases or decrease the number of UEs registered per network slice based on the information provided by the AMF in the update flag parameter.

If the update flag parameter from the AMF indicates increase, the following applies:
If the UE ID is already in the list of UEs registered with the network slice, the current number of UEs is not increased as the UE has already been counted as registered with the network slice. The NSACF creates a new entry associated with this new update and shall also maintain the old entry associated with previous update. The multiple entries for the same UE ID in the NSACF are differentiated based on the NF ID of the NF sending the update request. The NSACF removes the entry associated with the NF ID upon reception of a request having update flag indicating decrease.

NOTE 2: The use case of having two or more entries in the NSACF for the same UE can happen during (a) inter-AMF mobility when the new AMF request update to the NSACF before the old AMF sends request to deregister the UE; or (b) PDN connections establishment in the EPC when multiple SMF+PGW-Cs (i.e. used for different PDN Connections associated with the same S-NSSAI) send update requests for maximum number of UEs to the NSACF.
If the UE ID is not in the list of UE IDs registered with the network slice and the maximum number of UEs registered with the network slice has not been reached yet, the NSACF adds the UE ID in the list of UEs registered with the network slice as a new entry associated with this new update and increases the current number of the UEs registered with the network slice. If the UE ID is not in the list of UEs registered with that S-NSSAI and the maximum number of UEs for that S-NSSAI has already been reached, then the NSACF returns a result parameter indicating that the maximum number of UEs registered with the network slice has been reached.

If the update flag parameter from the AMF indicates decrease and if there is only one entry associated with the UE ID, the NSACF removes the UE ID from the list of UEs registered with the network slice for each of the S-NSSAI(s) indicated in the request from the AMF and also the NSACF decreases the number of UEs per network slice that is maintained by the NSACF for each of these network slices. If there are multiple entries associated with the UE ID, the NSACF removes the entry associated with the NF ID but the UE ID is kept in the list of UEs registered with the S-NSSAI.

The NSACF takes access type into account for increasing and decreasing the number of UEs per network slice as described in clause 5.15.11.1 of TS 23.501 [2].

The NSACF stores the notification endpoint for EAC Notification associated with the S-NSSAI if it is received from the AMF. The NSACF can use this AMF notification endpoint to update the EAC mode as described in clause 4.2.11.3.

NOTE 3: This enables the NSACF to maintain up-to-date information about the AMFs serving the S-NSSAIs.

If the AMF included usage control parameter set to ON for one or more network slices for the UE and an usage control timer value, the NSACF starts usage control timers for these network slice for the UE with the timer value provided by the AMF. Alternatively, the usage control timer value could be a configured value in the NSACF. The usage control timer for a certain network slice for a UE is stop when a PDU session is established on that network slice by the UE and it is re-started as soon as the PDU Session is released.
4. The NSACF returns the Nnsacf_NSAC_NumOfUEsUpdate_Response in which the NSACF includes the S-NSSAI(s) for which the maximum number of UEs per network slice has already been reached along with a result parameter indicating that the maximum number of UEs registered with the network slice has been reached.

If a usage control timer for a network slice expires for the UE, e.g. the network slice has not been used by the UE for the duration of the usage control timer, the NSACF deregisters the UE from the network slice, i.e. the NSACF decreases the UE count for the network slice and removes the UE identity from the list of the UEs registered with the network slice. Then the NSACF returns Nnsacf_NSAC_DeregistrationNotification message to the AMF in which the NSACF includes the UE Identity, the network slice identity and a reject cause set to ‘usage control timer expired’.

At UE Registration procedure, if only some of the S-NSSAIs reached the maximum number of UEs per S-NSSAI, the AMF sends a Registration Accept message to the UE in which the AMF includes the rejected S-NSSAI(s) in the rejected NSSAI list for which the NSACF has indicated that the maximum number of UEs per network slice has been reached, and for each rejected S-NSSAI the AMF includes a reject cause set to ‘maximum number of UEs per network slice reached’ and optionally a back-off timer.

When for all the Requested S-NSSAI(s) provided in step 2 the NSACF returned the maximum number of UEs per network slice has been reached and if one or more subscribed S-NSSAIs are marked as default in the subscription data and not subject to Network Slice Admission Control, the AMF can decide to include these Default Subscribed S-NSSAIs in the Allowed NSSAI. Otherwise, the AMF rejects the UE request for registration. In the Registration Reject message the AMF includes the rejected S-NSSAI(s) in the rejected NSSAI parameter, and for each rejected S-NSSAI the AMF includes a reject cause to indicate that the maximum number of UEs per network slice has been reached and optionally a back-off timer.

NOTE 4: If the use case requires the UE to remain reachable at all times with at least one slice, it is recommended that at least one of the Subscribed S-NSSAIs is marked as the default S-NSSAI which is not subject to Network Slice Admission Control. This will ensure the UE is able to access to services even when maximum number of UEs per network slice has been reached.

<4.2.11.4 Number of PDU Sessions per network slice availability check and update procedure>

The number of PDU Sessions per network slice availability check and update procedure is to update (i.e. increase or decrease) the number of PDU Sessions established on S-NSSAI which is subject to NSAC. The SMF is configured with the information indicating which network slice is subject to NSAC.

NOTE 1: EAC mode is not applicable for Number of PDU Sessions per network slice availability check and update procedure.

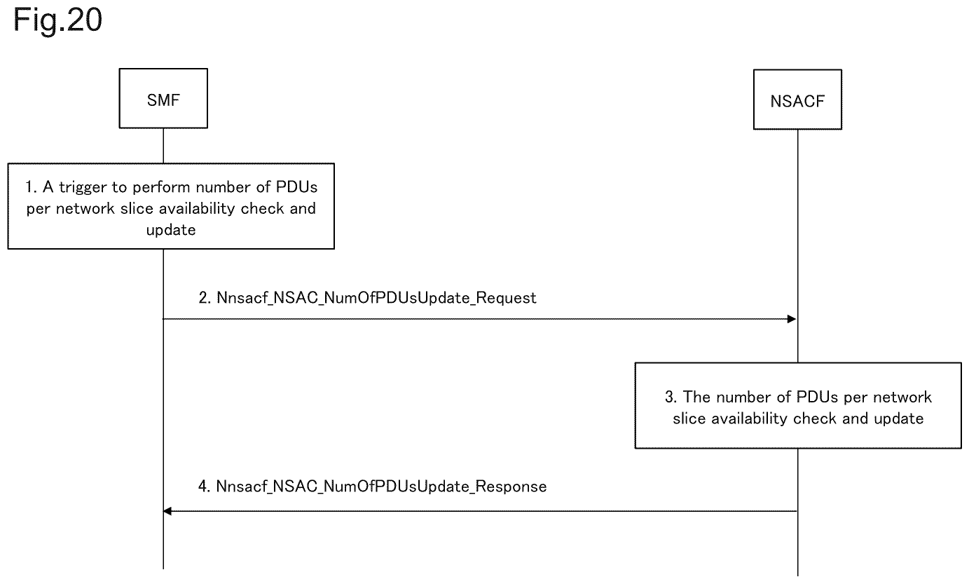

FIG. 4.2.11.4-1: Number of PDU Sessions per network slice availability check and update procedure (See FIG. 20.)
1. If the SMF is not aware of which NSACF to communicate, the SMF performs NSACF discovery as described in clause 6.3.22 of TS 23.501 [2] and in clause 5.2.7.3.2. The SMF anchoring the PDU session triggers the Number of PDU Sessions per network slice availability check and update procedure for the network slices that are subject to NSAC at the beginning of a PDU Session Establishment procedure (clause 4.3.2.2.1 and clause 4.3.2.2.2) only for new PDU Sessions to be established, and as a last step of successful PDU Session Release procedure (clause 4.3.4.2 and clause 4.3.4.3).

NOTE 2: SMFs handling PDU sessions associated with UE Request Type “Existing PDU Session” for handover purposes do not interact with the NSACF.
2. The SMF anchoring the PDU session sends Nnsacf_NSAC_NumOfPDUsUpdate_Request message to the NSACF. The SMF includes in the message the UE-ID, the PDU session ID, S-NSSAI for which the number of PDU Sessions per network slice update is required, access type and the update flag which indicates that the number of PDUs established on the S-NSSAI is to be increased if the procedure is triggered at the beginning of PDU Session Establishment procedure or indicates that the number of PDU Sessions on the S-NSSAI is to be decreased if the procedure is triggered at the end of PDU Sessions Release procedure.

NOTE 3: For SSC mode 3 PDU session, the SMF of the new PDU Session invokes the NSACF to increase the number of PDU Session and adds the new PDU session ID in the NSACF. When the old PDU session is released the SMF of the old PDU session invokes the NSACF to decrease the number of PDU Session and remove the old PDU session ID in the NSACF.

NOTE 4: An SMF anchoring an IPv6 Multi-homed PDU session does not invoke NSACF for an S-NSSAI subject to NSAC when the PDU session replaces an existing anchor according to clause 4.3.5.3.
3. The NSACF updates the current number of PDU Sessions established on the S-NSSAI, i.e. increase or decrease the number of PDU Sessions per network slice based on the information provided by the anchor SMF in the update flag parameter.

If the update flag parameter from the SMF anchoring the PDU session indicates increase and the maximum number of PDU Sessions established on the S-NSSAI has already been reached, then the NSACF returns a result parameter indicating that the maximum number of PDU Sessions per network slice has been reached. If the maximum number of PDU Sessions established on the S-NSSAI has not been reached, the NSACF checks the UE ID. If the UE ID is located, the NSACF, stores the PDU Session ID, and increases the number of PDU Sessions for that S-NSSAI. If the NSACF did not locate the UE ID, it creates an entry for the UE ID, stores the PDU Session ID, and increases the number of PDU Sessions for that S-NSSAI.

If the update flag parameter from the SMF anchoring the PDU session indicates decrease the current number of PDU Sessions per S-NSSAI, the NSACF locates the UE ID, and decreases the number of PDU Sessions for that S-NSSAI and its related PDU Session ID. If the UE ID has no more PDU sessions, after the decrease, the NSACF removes the UE ID entry.

The NSACF takes access type into account for increasing and decreasing the number of PDU Sessions per S-NSSAI as described in clause 5.15.11.2 of TS 23.501 [2].

If the NSACF has active usage control timer running for a network slice for the UE, the NSACF stops the usage control timer if the update flag for the network slice is set to increase, i.e. a new PDU session is established by the UE on the network slice. The NSACF re-starts the usage control timer for the network slice if the update flag for the network slice is set to decrease, i.e. an active PDU session on the network slice has been released by the UE.
4. The NSACF acknowledges the update to the anchor SMF with Nnsacf_NSAC_NumOfPDUsUpdate_Response message. If the NSACF returned maximum number of PDU Sessions per S-NSSAI reached result, the SMF rejects the PDU Session establishment request with reject cause set to ‘maximum number of PDU Sessions per S-NSSAI reached’ and optionally a back-off timer.

In the case of a PDU Session Establishment failure, the anchor SMF triggers another request to the NSACF with the update flag parameter equal to decrease in order to re-adjust back the PDU Session counter in the NSACF.

### <5.2.21.2.2 Nnsacf_NSAC_NumOfUEsUpdate Service Operation>

### Service Operation Name: Nnsacf_NSAC_NumOfUEsUpdate

Description: Updates the number of UEs registered with a network slice (e.g. increase or decrease) when the UE registration status for a network slice subject to NSAC has changed. Also, if the number of the UEs registered with the network slice is to be increased and the Early Availability Check (EAC) mode in the NSACF is activated for that network slice (see Nnsacf_NSAC_EACNotify service operation), the NSACF first checks whether the number of UEs registered with the network slice has reached the maximum number of UEs per network slice threshold. If the maximum number of UEs registered with the network slice has already been reached, the UE registration for that network slice is rejected. If the EAC is not activated, the NSACF increases or decreases the number of UEs per network slice as per the input parameters below.

Inputs, Required: S-NSSAI(s), UE ID (SUPI), NF ID, access type, update flag.

Inputs, Conditional: Notification endpoint for EAC Notification for the S-NSSAI.

The S-NSSAI(s) parameter is a list of one or more network slices for which the number of UEs registered with a network slice is to be updated and checked if the maximum number of UEs per network slice threshold has already been reached.

The UE ID is used by the NSACF to maintain a list of UE IDs registered with the network slice. The NSACF also takes access type into account for increasing and decreasing the number of UEs per network slice as described in clause 5.15.11.1 of TS 23.501 [2].

The NF ID parameter is the NF instance ID of the NF (e.g. AMF or SMF+PGW-C) sending the request to the NSACF.

The update flag input parameter indicates whether the number of UEs registered with a network slice is to be:
increased when the UE registers to a new network slice subject to NSAC. If the UE ID is already in the list of UEs registered with the network slice, the number of UEs registered with the network slice is not increased as the UE has already been counted as registered with the network slice. If the UE ID is not in the list of UE IDs registered with the network slice and the maximum number of UEs registered with the network slice has not been reached yet, the NSACF adds the UE ID in the list of UEs registered with the network slice and increases the number of the UEs registered with the network slice. If the UE_ID is not in the list of UEs registered with that S-NSSAI and the maximum number of UEs per network slice for that S-NSSAI has already been reached, then the NSACF returns maximum number of UEs per network slice reached result;
decreased when the UE deregisters for a network slice that is subject to NSAC. The NSACF decreases the number of the UEs registered with the network slice and removes the UE ID from the list of UEs registered with the network slice.

If this is the first time to perform NSAC procedure for the S-NSSAI towards the NSACF, the AMF includes notification endpoint for EAC Notification to implicitly subscribe the EAC notification for the S-NSSAI from the NSACF.

Inputs, Optional: usage control, usage control timer

The usage control timer per a network slice for a UE is included if the network slice is subject to usage control, i.e. the UE is to be deregistered from the network slice by the NSACF if the network slice is not used by the UE for certain duration of time.

The usage control timer may be included if the network slice(s) are subject to usage control.

The NSACF may optionally return the current status of the network slice availability (e.g. a percentage out of the maximum number of UEs registered with a network slice) in the availability status parameter. This information may be used for NSACF signalling and load balancing in case multiple NSACFs are serving the same network slice.

Editor's note: It is FFS how to support in case multi NSACF is supported, e.g. discover the same NSACF, coordination of the local maximum number among NSACF.

Outputs, Required: maximum number of UEs per network slice reached, availability status.

### <5.2.21.x.x Nnsacf_NSAC_DeregistrationNotification Service Operation>

### Service Operation Name: Nnsacf_NSAC_DeregistrationNotification

Description: Notifies for a network slice for which the UE was deregistered from by the NSACF due to the usage control timer expiry for that network slice for the UE.

Inputs, Required: UE_ID, S-NSSAI, reject cause.

The UE_ID parameter is the UE identity which is deregistered from the network slice due to the usage control timer expiry

The S-NSSAI parameter is the network slice identity which the UE has not used for the duration of the usage control timer

The reject cause parameter is set to ‘usage control timer expired’ if the UE has not used the S-NSSAI for the duration of the usage control timer.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

The whole or part of the example embodiments disclosed above can be described as, but not limited to, the following supplementary notes.
supplementary note 1. A method of a communication apparatus, the method comprising:
sending a first message,
wherein the first message includes Single Network Slice Selection Assistance Information (S-NSSAI);
receiving a second message in a case where the S-NSSAI is not used for a time period,
wherein the second message includes the S-NSSAI and a reject cause indicating that the S-NSSAI is not used for the time period, and
wherein the time period is associated with the S-NSSAI; and
sending a third message to remove the S-NSSAI from an Allowed Network Slice Selection Assistance Information (NSSAI),
wherein the third message includes the S-NSSAI and the reject cause.
supplementary note 2. The method according to supplementary note 1,
wherein the first message is sent for Network Slice Admission Control (NSAC), and
wherein the NSAC is performed in a case where the time period lapses.
supplementary note 3. The method according to supplementary note 2,
wherein the NSAC includes decrement of a number of User Equipments (UEs).
supplementary note 4. The method according to any one of supplementary notes 1 to 3,
wherein the time period is configured by the communication apparatus, and
wherein the time period is included in the first message.
supplementary note 5. A method of a communication apparatus, the method comprising:
receiving a first message,
wherein the first message includes Single Network Slice Selection Assistance Information (S-NSSAI);
starting a timer for the S-NSSAI after receiving the first message,
wherein the timer is set to a value associated with the S-NSSAI;
performing Network Slice Admission Control (NSAC) in a case where the timer expires; and
sending a second message after performing the NSAC,
wherein the second message includes the S-NSSAI and a reject cause indicating expiry of the timer.
supplementary note 6. The method according to supplementary note 5,
wherein the first message is for the NSAC.
supplementary note 7. The method according to supplementary note 5 or 6, wherein the NSAC includes decrement of a number of User Equipments (UEs).
supplementary note 8. The method according to any one of supplementary notes 5 to 7,
wherein the value is configured by the communication apparatus.
supplementary note 9. The method according to any one of supplementary notes 5 to 8, further comprising:
receiving a third message related to a Protocol Data Unit (PDU) session for the S-NSSAI after starting the timer; and
stopping the timer after receiving the third message.
supplementary note 10. A method of a User Equipment (UE), the method comprising:
performing a registration for Single Network Slice Selection Assistance Information (S-NSSAI); and
receiving a message,
wherein the message includes the S-NSSAI and a reject cause indicating that the S-NSSAI is not used for a time period, and
wherein the time period is associated with the S-NSSAI; and
removing the S-NSSAI from an Allowed Network Slice Selection Assistance Information (NSSAI) after receiving the message.
supplementary note 11. A method of a communication apparatus, the method comprising:
receiving a first message,
wherein the first message includes Single Network Slice Selection Assistance Information (S-NSSAI);
starting a timer for the S-NSSAI after receiving the first message,
wherein the timer is set to a value associated with the S-NSSAI; and
sending a second message for Network Slice Admission Control (NSAC) and a third message in a case where the timer expires,
wherein the second message includes the S-NSSAI, and
wherein the third message includes the S-NSSAI and a reject cause indicating expiry of the timer.
supplementary note 12. The method according to supplementary note 11,
wherein the NSAC includes decrement of a number of User Equipments (UEs).
supplementary note 13. The method according to supplementary note 11 or 12,
wherein the value is configured by the communication apparatus.
supplementary note 14. The method according to any one of supplementary notes 11 to 13, further comprising:
receiving a fourth message related to a Protocol Data Unit (PDU) session for the S-NSSAI after starting the timer; and
   stopping the timer after receiving the fourth message.
supplementary note 15. A method of a communication apparatus, the method comprising:
receiving a first message,
wherein the first message includes Single Network Slice Selection Assistance Information (S-NSSAI);
starting a timer for the S-NSSAI after receiving the first message,
wherein the timer is set to a value associated with the S-NSSAI;
receiving a second message related to establishment of a Protocol Data Unit (PDU) session for the S-NSSAI after starting the timer;
stopping the timer after receiving the second message;
receiving a third message related to release of the PDU session after stopping the timer;
starting the timer after receiving the third message; and
sending a fourth message in a case where the timer expires,
wherein the fourth message is for removing the S-NSSAI from an Allowed Network Slice Selection Assistance Information (NSSAI) or is for deregister the S-NSSAI.
supplementary note 16. A method of a communication apparatus, the method comprising:
sending a first message,
wherein the first message includes Single Network Slice Selection Assistance Information (S-NSSAI);
receiving a second message,
wherein the second message includes identity of a Protocol Data Unit (PDU) session;
starting a timer after receiving the second message;
sending a third message in a case where there is no user plane activity for the PDU session until the timer expires,
wherein the third message indicates that there is no user plane activity for the PDU session;
receiving a fourth message after sending the third message; and
performing a procedure to release the PDU session after receiving the fourth message.
supplementary note 17. A method of a communication apparatus, the method comprising:
receiving a first message,
wherein the first message includes Single Network Slice Selection Assistance Information (S-NSSAT);
sending a second message,
   wherein the second message includes identity of a Protocol Data Unit (PDU) session; receiving a third message after sending the second message,
   wherein the third message indicates that there is no user plane activity for the PDU session; and
   sending a fourth message after receiving the third message,
   wherein the fourth message is for performing a procedure to release the PDU session.
supplementary note 18. A communication apparatus comprising:
means for sending a first message,
wherein the first message includes Single Network Slice Selection Assistance Information (S-NSSAI);
means for receiving a second message in a case where the S-NSSAI is not used for a time period,
wherein the second message includes the S-NSSAI and a reject cause indicating that the S-NSSAI is not used for the time period, and
wherein the time period is associated with the S-NSSAI; and
means for sending a third message to remove the S-NSSAI from an Allowed Network Slice Selection Assistance Information (NSSAI),
wherein the third message includes the S-NSSAI and the reject cause.
supplementary note 19. The communication apparatus according to supplementary note 18,
wherein the first message is sent for Network Slice Admission Control (NSAC), and
wherein the NSAC is performed in a case where the time period lapses.
supplementary note 20. The communication apparatus according to supplementary note 19,
wherein the NSAC includes decrement of a number of User Equipments (UEs).
supplementary note 21. The communication apparatus according to any one of supplementary notes 18 to 20,
wherein the time period is configured by the communication apparatus, and
wherein the time period is included in the first message.
supplementary note 22. A communication apparatus comprising:
means for receiving a first message,
wherein the first message includes Single Network Slice Selection Assistance Information (S-NSSAI);
means for starting a timer for the S-NSSAI after receiving the first message,
wherein the timer is set to a value associated with the S-NSSAI;
means for performing Network Slice Admission Control (NSAC) in a case where the timer expires; and
   means for sending a second message after performing the NSAC,
   wherein the second message includes the S-NSSAI and a reject cause indicating expiry of the timer.
supplementary note 23. The communication apparatus according to supplementary note 22,
wherein the first message is for the NSAC.
supplementary note 24. The communication apparatus according to supplementary note 22 or 23,
wherein the NSAC includes decrement of a number of User Equipments (UEs).
supplementary note 25. The communication apparatus according to any one of supplementary notes 22 to 24,
wherein the value is configured by the communication apparatus.
supplementary note 26. The communication apparatus according to any one of supplementary notes 22 to 25, further comprising:
means for receiving a third message related to a Protocol Data Unit (PDU) session for the S-NSSAI after starting the timer; and
means for stopping the timer after receiving the third message.
supplementary note 27. A User Equipment (UE) comprising:
means for performing a registration for Single Network Slice Selection Assistance Information (S-NSSAI); and means for receiving a message,
wherein the message includes the S-NSSAI and a reject cause indicating that the S-NSSAI is not used for a time period, and
wherein the time period is associated with the S-NSSAI; and
means for removing the S-NSSAI from an Allowed Network Slice Selection Assistance Information (NSSAI) after receiving the message.
supplementary note 28. A communication apparatus comprising:
means for receiving a first message,
wherein the first message includes Single Network Slice Selection Assistance Information (S-NSSAI);
means for starting a timer for the S-NSSAI after receiving the first message,
wherein the timer is set to a value associated with the S-NSSAI; and
means for sending a second message for Network Slice Admission Control (NSAC) and a third message in a case where the timer expires,
wherein the second message includes the S-NSSAI, and
wherein the third message includes the S-NSSAI and a reject cause indicating expiry of the timer.
supplementary note 29. The communication apparatus according to supplementary note 28,
   wherein the NSAC includes decrement of a number of User Equipments (UEs).
supplementary note 30. The communication apparatus according to supplementary note 28 or 29,
wherein the value is configured by the communication apparatus.
supplementary note 31. The communication apparatus according to any one of supplementary notes 28 to 30, further comprising:
means for receiving a fourth message related to a Protocol Data Unit (PDU) session for the S-NSSAI after starting the timer; and means for stopping the timer after receiving the fourth message.
supplementary note 32. A communication apparatus comprising:
means for receiving a first message,
wherein the first message includes Single Network Slice Selection Assistance Information (S-NSSAI);
means for starting a timer for the S-NSSAI after receiving the first message,
wherein the timer is set to a value associated with the S-NSSAI;
means for receiving a second message related to establishment of a Protocol Data Unit (PDU) session for the S-NSSAI after starting the timer;
means for stopping the timer after receiving the second message;
means for receiving a third message related to release of the PDU session after stopping the timer;
means for starting the timer after receiving the third message; and
means for sending a fourth message in a case where the timer expires,
wherein the fourth message is for removing the S-NSSAI from an Allowed Network Slice Selection Assistance Information (NSSAI) or is for deregister the S-NSSAI.
supplementary note 33. A communication apparatus comprising:
means for sending a first message,
wherein the first message includes Single Network Slice Selection Assistance Information (S-NSSAI);
means for receiving a second message,
wherein the second message includes identity of a Protocol Data Unit (PDU) session;
means for starting a timer after receiving the second message;
means for sending a third message in a case where there is no user plane activity for the PDU session until the timer expires,
wherein the third message indicates that there is no user plane activity for the PDU session;
means for receiving a fourth message after sending the third message; and
means for performing a procedure to release the PDU session after receiving the fourth message.
supplementary note 34. A communication apparatus comprising:
means for receiving a first message,
wherein the first message includes Single Network Slice Selection Assistance Information (S-NSSAI);
means for sending a second message,
wherein the second message includes identity of a Protocol Data Unit (PDU) session;
means for receiving a third message after sending the second message,
wherein the third message indicates that there is no user plane activity for the PDU session; and
means for sending a fourth message after receiving the third message,
wherein the fourth message is for performing a procedure to release the PDU session.
supplementary note 35. A method for a first core network apparatus comprising: receiving, from a second core network apparatus, a fourth message related to management of a network slice;
starting a timer for the network slice after receiving the fourth message;
detecting the timer is expired; and
sending, to the second core network apparatus, a fifth message indicating at least one of the timer is expired or the network slice related to the timer is not used, after the detecting the timer is expired.
supplementary note 36. A method for a first core network apparatus comprising:
receiving, from a second core network apparatus, a fourth message related to management of a network slice;
starting a timer for the network slice after receiving the fourth message;
detecting an activity related to the network slice; and
stopping the timer after the detecting the activity.
supplementary note 37. A method for a third core network apparatus comprising:
analysing a data related to a network where the third core network apparatus belongs to;
receiving, from a first core network apparatus, a sixth message related to management of a network slice;
starting a timer for the network slice after receiving the sixth message; detecting the timer is expired; and
sending, to the first core network apparatus, a seventh message indicating at least one of the timer is expired or the network slice related to the timer is not used, after the detecting the timer is expired, wherein the first core network apparatus manages network slice admission control.
supplementary note 38. A method for a third core network apparatus comprising:
   analysing a data related to a network where the third core network apparatus belongs to;
   receiving, from a first core network apparatus, a sixth message related to management of a network slice;
   starting a timer for the network slice after the receiving the sixth message;
   detecting an activity related to the network slice; and
   stopping the timer after the detecting the activity, wherein the first core network apparatus manages network slice admission control.
supplementary note 39. A method for a first network slice control function node comprising:
receiving, from a second core network apparatus, an eighth message related to management of a network slice;
starting a timer for the network slice after receiving the eighth message;
detecting the timer is expired; and
sending, to the second core network apparatus, a ninth message indicating at least one of the timer is expired or the network slice related to the timer is not used, after the detecting the timer is expired.
supplementary note 40. A method for a first network slice control function node comprising:
receiving, from a second core network apparatus, a tenth message related to management of a network slice;
starting a timer for the network slice after receiving the tenth message;
receiving, from a second network slice control function node, eleventh message
   detecting an activity related to the network slice; and
stopping the timer after receiving the eleventh message.
supplementary note 41. A method for a third core network apparatus comprising:
sending, to a first core network apparatus, first information related to management of a network slice to initiate a control of a number of sessions based on a timer;
receiving, from the first core network apparatus, second information indicating the control is initiated;
monitoring user plane activity related to the sessions after receiving the second information;
sending, to the first core network apparatus, third information indicating the user plane activity is not detected based on the monitoring; and
receiving, from the first core network apparatus, fourth information indicating at least one of the timer is expired or the is not active within a period specified by the timer.
supplementary note 42. A method for a first core network apparatus comprising:
receiving, from a third core network apparatus, fifth information related to management of a network slice;
   starting a timer for the network slice after receiving the fifth information; sending, to the third core network apparatus, sixth information indicating the management is initiated to start monitoring user plane activity related to the network slice;
   receiving, from the third core network apparatus, seventh information indicating the user plane activity is not detected based on the monitoring; and
   sending, to the third core network apparatus, eighth information indicating at least one of the timer is expired or the sessions is not active within a period specified by the timer.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian pro-visional patent application No. 202111060026, filed on Dec. 22, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NWDAF
77 NSACF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
771 transceiver circuit
772 network interface
773 controller
774 memory
3621 transceiver control module
5521 transceiver control module
6051 operating system
6052 communications control module
6141 operating system
6142 communications control module
6241 operating system
6242 communications control module
7041 operating system
7042 communications control module
7241 operating system
7242 communications control module
7341 operating system
7342 communications control module
7441 operating system
7442 communications control module
7541 operating system
7542 communications control module
7641 operating system
7642 communications control module
7701 NSACF
7702 NSACF
7741 operating system
7742 communications control module
60521 transceiver control module
61421 transceiver control module
62421 transceiver control module
70421 transceiver control module
72421 transceiver control module
73421 transceiver control module
74421 transceiver control module
75421 transceiver control module
76421 transceiver control module
77421 transceiver control module

What is claimed is:

1. A method for a Session Management Function (SMF) comprising:
releasing a Protocol Data Unit (PDU) session related to a network slice in a case where a session timer expires; and
indicating a release cause while the releasing.

2. The method according to claim 1, wherein the release cause is related to a slice inactivity.

3. The method according to claim 1 comprising: configuring a session timer value.

4. The method according to claim 1, wherein the session timer is a timer for a session inactivity timer.

5. The method according to claim 4, wherein the session timer is related to a PDU session.

6. A Session Management Function (SMF) comprising:
a memory; and
at least one processor configured to access the memory and configured to:
release a Protocol Data Unit (PDU) session related to a network slice in a case where a session timer expires; and
indicate a release cause while the release.

7. The SMF according to claim 6, wherein the release cause is related to a slice inactivity.

8. The SMF according to claim 6, wherein the processor is configured to configure a session timer value.

9. The SMF according to claim 6, wherein the session timer is a timer for a session inactivity timer.

10. The SMF according to claim 9, wherein the session timer is related to a PDU session.

11.-42. (canceled)
